(19) United States
(12) Patent Application Publication
(10) Pub. No.: US 2004/0243483 A1
(43) Pub. Date: Dec. 2, 2004

(54) Mechanical engineering web portal

(75) Inventors: Georg Baumann, Amberg (DE); Pierre-Alain Cotte, Amberg (DE)

Correspondence Address: SCHWEGMAN, LUNDBERG, WOESSNER & KLUTH, P.A., P.O. BOX 2938, MINNEAPOLIS, MN, 55402, US

(73) Assignee: web2cad AG

(21) Appl. No.: 10/449,856

(22) Filed: May 29, 2003

Related U.S. Application Data
(63) Continuation of application No. 09/590,208, filed on Jun. 8, 2000, now abandoned.
Application No. 09/590,208 is a continuation-in-part of application No. 09/365,341, filed on Jul. 30, 1999, now abandoned.

(51) Int. Cl. G06F 17/60

(52) U.S. Cl. 705/27

(57) ABSTRACT

Systems and methods for implementing an engineering web portal are disclosed. The system maintains a database of data and drawings for parts sold by a vendor. The drawings can be downloaded to a client and inserted into a CAD system, whereupon the vendor charged a fee for each drawing downloaded. The database of parts can be searched for parts meeting a user's requirements. The parts resulting from the search can be submitted to a search engine that searches for auctions that offer the part for bidding.

### RELATED FILES

This application is a continuation in part of U.S. patent application Ser. No. 09/365,341, entitled “MECHANICAL ENGINEERING WEB PORTAL” <Attorney Docket #11154.001US1>, which is hereby incorporated by reference herein for all purposes.

### FIELD

The present invention relates generally to the field of electronic data processing systems, and more particularly to Internet-based engineering systems.

### BACKGROUND

The use of computer aided design (CAD) tools to engineer devices is widespread and has resulted in great improvements in efficiency and quality. Conventional systems provide engineering drawings of components that can be assembled and/or coupled to other components from the vendor of the component. Furthermore, each vendor of components must create the electronic drawings for the components that each individual vendor offers for sale. The formats for the electronic drawings vary between CAD system vendors, and within a single vendor. For example, the AutoCAD system supports .dwg, .dxf and .dxb files. Other file formats include sat, .gcd and .tif files.

In addition, the channels of distribution of the electronic drawings from the vendor to the engineer user are various. For example, a manufacturer may choose to make drawings available for purchase on a CD. The engineer user of the components must receive the drawings in the various formats and through the various electronic delivery channels, and perform a variety of processes, such as format conversion, in order to integrate the drawings into a CAD system of the engineer user. In addition, vendors often charge fees for the drawings, in which case, the engineer user of the drawings will receive invoices from a number of vendors, resulting in high administrative costs to track and pay the invoices. Furthermore, when an engineer user solicits bids or places orders for components, the engineer user must negotiate the quantity and delivery time with each individual vendor using a number of different processes, which introduces risk that the bids and orders are not received correctly by the vendor, and increases the administrative transaction costs to the engineer user and the vendor.

Conventional systems of distributing electronic drawings of components have no ability to structure or organize the requests for drawings from the engineer user to the component vendor on the basis of the project that the component is associated with, or keywords that describe the component and attributes of the component keywords. Furthermore, drawings are not structured or organized in a manner that indicates a relationship between the component and a sub-component. In addition, previous systems do not provide a means of loading a parts model directly into a CAD system.

Previous systems and products fail to solve the problem of providing a convenient source of engineering drawings of components from vendors, a convenient and reliable channel of soliciting bids and placing orders at multiple vendors for the components, a convenient system for associating the component to the project of engineer user, and an association between a component and the sub-components of the components.

Furthermore, previous systems do not provide the ability to search for component parts from a variety of different sources that include both standard suppliers and auction sites that may have supplies of desired components.

For the reasons stated above, and for other reasons stated below which will become apparent to those skilled in the art upon reading and understanding the present specification, there is a need in the art for the present invention

### SUMMARY

The above-mentioned shortcomings, disadvantages and problems are addressed by the present invention, which will be understood by reading and studying the following specification.

The systems and methods presented below describe an engineering web portal according to embodiments of the invention that provides engineering drawings and data to a user and also provides the ability to select and purchase parts. According to one aspect of the invention, the web portal resides on a server that maintains a database of parts drawings. The parts drawings represent parts available from a vendor. The drawings can either be drawings created by the vendor, or they can be created by the web portal provider based on information provided by the vendor, such as a parts catalogue. A customer at a client computer can use a browser to view pages downloaded by the web portal. The pages provide a mechanism for the user to select one or more drawings to be downloaded to the client computer. In one aspect of the system, the vendor is charged for each drawing downloaded to a client computer. This provides revenue to the portal provider, and reduces the up-front costs to the vendor for providing drawings to customers, because the vendor does not have to create the drawings if the portal provider creates them on their behalf.

In an additional aspect of the system, the part drawings are customized according to parameters provided by the user.

In a further aspect of the system, the system provides an interactive purchasing agent (IPA) component. The IPA in one embodiment of the invention is a set of web pages that provide the ability for a client and vendor to manage a parts purchase transaction for one or more projects. The web pages interface with a database maintained by the portal provider that stores the current state of the purchase transaction for the project. In one embodiment of the invention, the states include inquiry, offer, offer approval, order, order confirmation, delivery status, goods receipt, and a reception note. Each state requires that one of the parties (client or vendor) provide information to complete the state.

In a still further aspect of the system, the system provides an interactive search engine that provides a mechanism for a user to search for a part suitable for the user's application. The user provides parameters to the search engine describing the part. The parameters can be related to the dimensions of the parts, for example, the bore and stroke of a cylinder. In addition, the parameters can be attributes related to the environment in which the part must operate. For example, the mass of an object along with the distance and frequency that the object must be moved can be supplied as search parameters. The system then calculates the size of the part that can perform according to the parameters, and presents a list of parts or parts vendors that meet the desired criteria.

Another aspect of the system is that the system can be configured to search on-line auctions for parts matching parameters supplied by the user. The on-line auction can be maintained by the system itself, or it can be maintained by one or more third parties.

In a further aspect of the system, the search engine provides a list of engineering services providers that are selected according to bid conditions and other criteria provided by a user. The system can track information regarding the interaction between the service providers and service requesters. For example, the system can track the response time provided by service providers, and use this information to rank service providers. Furthermore, the tracking information can be used to determine if a commission is due in exchange for the referral of the user to the service provider.

The present invention describes systems, clients, servers, methods, and computer-readable media of varying scope. In addition to the aspects and advantages of the present invention described in this summary, further aspects and advantages of the invention will become apparent by reference to the drawings and by reading the detailed description that follows.

### BRIEF DESCRIPTION OF THE DRAWINGS

FIG. 1 is a block diagram of the hardware and operating environment in which different embodiments of the invention can be practiced;

FIG. 2 is a block diagram illustrating a system-level overview of an exemplary embodiment of the invention;

FIG. 3 is an illustration of an engineering web portal page according to an embodiment of the invention;

FIGS. 4A-4I describe an electronic search assistant and search engine according to an embodiment of the invention;

FIG. 4J provides an illustration of a geographic search screen according to an embodiment of the invention;

FIGS. 5A-5I describe an interactive purchasing agent according to a further embodiment of the invention;

FIG. 5J is a flowchart illustrating a method for managing stages of a purchase transaction according to an embodiment of the invention;

FIG. 5K provides an illustration of an exemplary inquiry screen according to an embodiment of the invention;

FIGS. 6A-6H describe a drawing download component according to a further embodiment of the invention;

FIG. 7 is a flowchart illustrating a method for downloading a drawing and charging a vendor according to an embodiment of the invention;

FIG. 8 is a flowchart illustrating a method for searching a database for a part according to an embodiment of the invention; and

FIG. 9 is a flowchart illustrating a method for searching a database for a service provider according to an embodiment of the invention.

### DETAILED DESCRIPTION

In the following detailed description of exemplary embodiments of the invention, reference is made to the accompanying drawings which form a part hereof, and in which is shown by way of illustration specific exemplary embodiments in which the invention may be practiced. These embodiments are described in sufficient detail to enable those skilled in the art to practice the invention, and it is to be understood that other embodiments may be utilized and that logical, mechanical, electrical and other changes may be made without departing from the scope of the present invention. The following detailed description is, therefore, not to be taken in a limiting sense, and the scope of the present invention is defined only by the appended claims.

Some portions of the detailed description which follows are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like. It should be borne in mind, however, that all of these and similar terms are to be associated with the appropriate physical quantities and are merely convenient labels applied to these quantities. Unless specifically stated otherwise as apparent from the following discussions, it is appreciated that throughout the present invention, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The detailed description that follows is divided into multiple sections. The first section describes a hardware environment in which the various embodiments of the invention can operate. The second section describes a system level overview of software environment in which various embodiments of the invention operate. The third section provides an overview of a mechanical engineering web portal according to an embodiment of the invention. The fourth section provides a description of a engineering parts electronic search assistant and search engine. The fifth section describes an interactive purchasing agent component of the web portal, according to an embodiment of the invention. The sixth section describes a catalogue of engineering CAD (Computer Aided Design) drawings available for download by a client. The final section is a conclusion of the detailed description.

### Hardware Environment

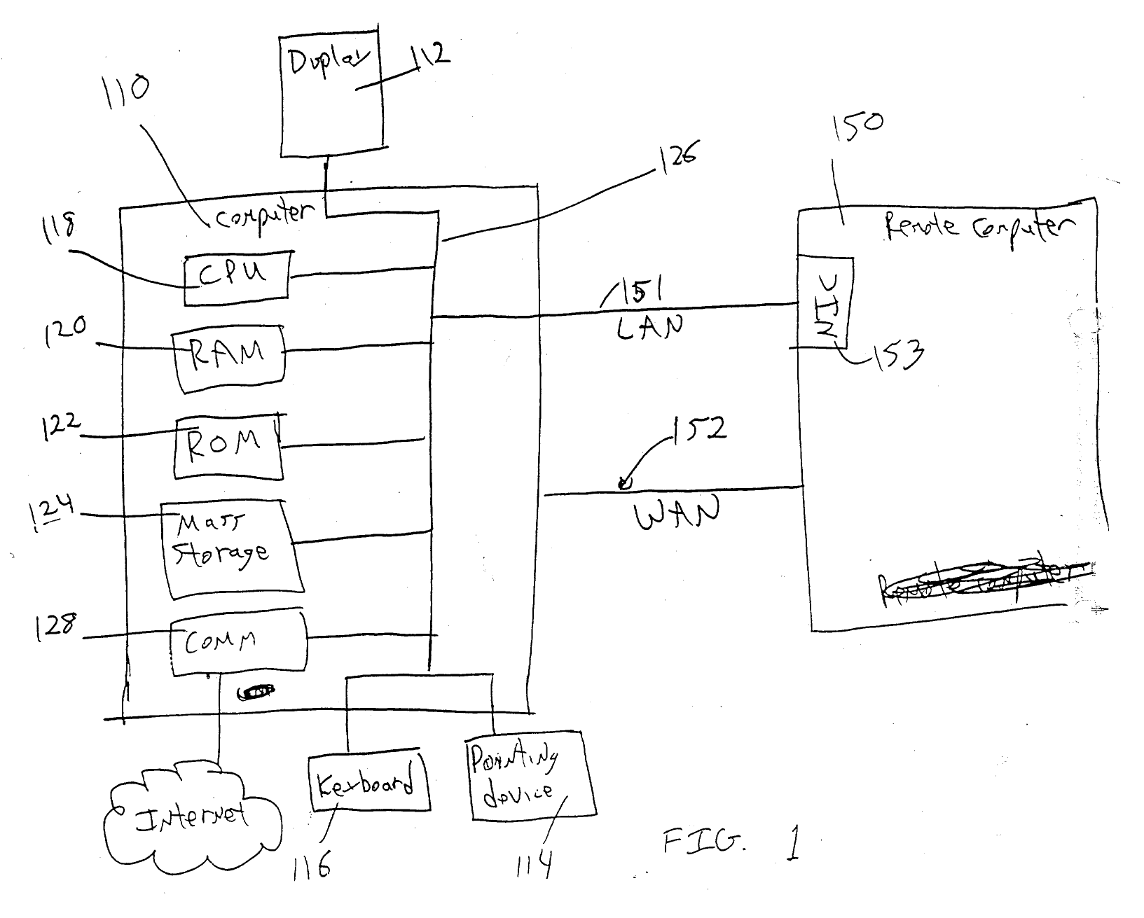

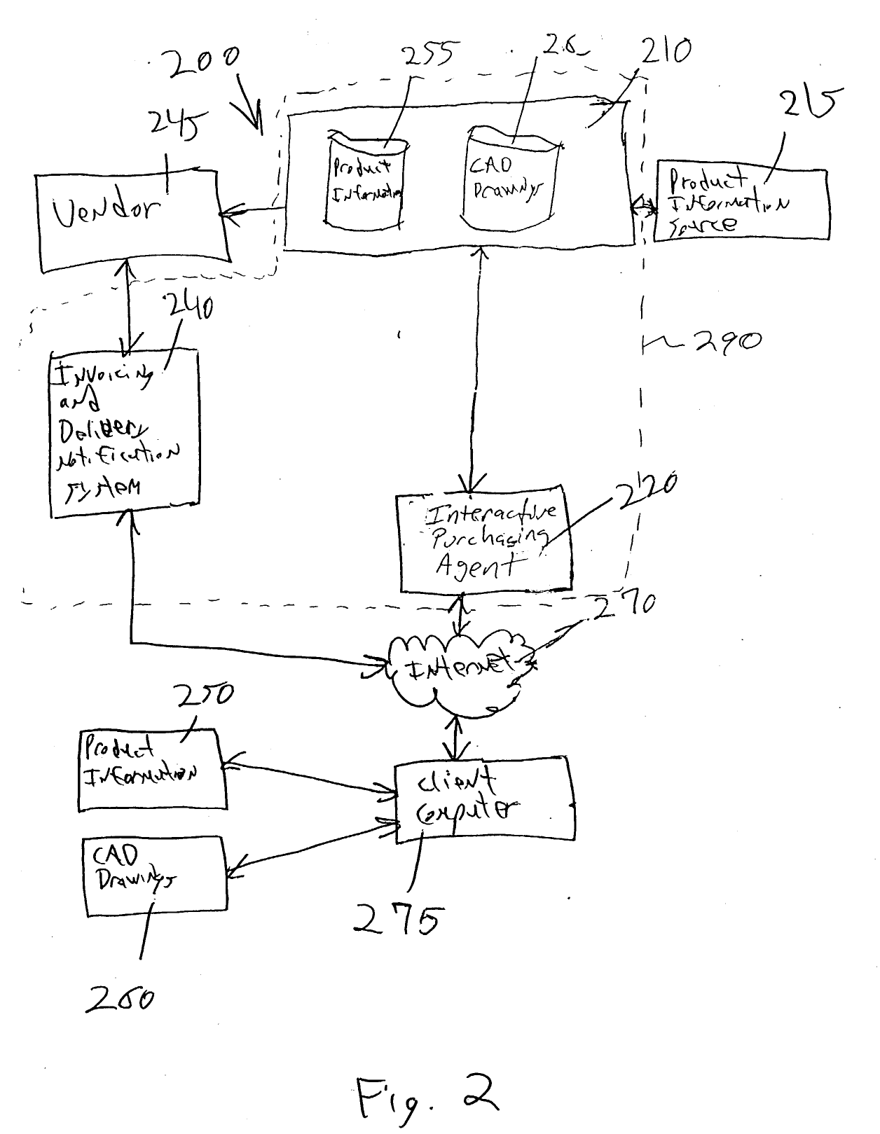

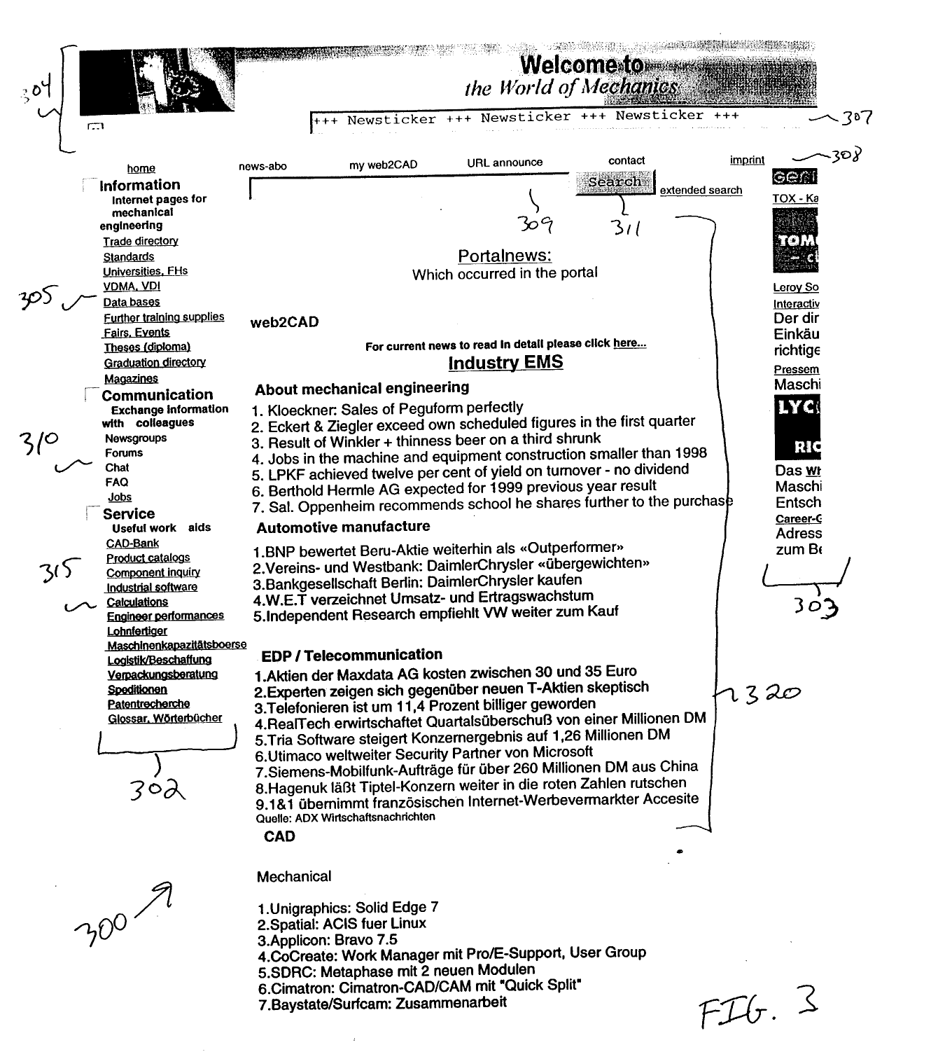

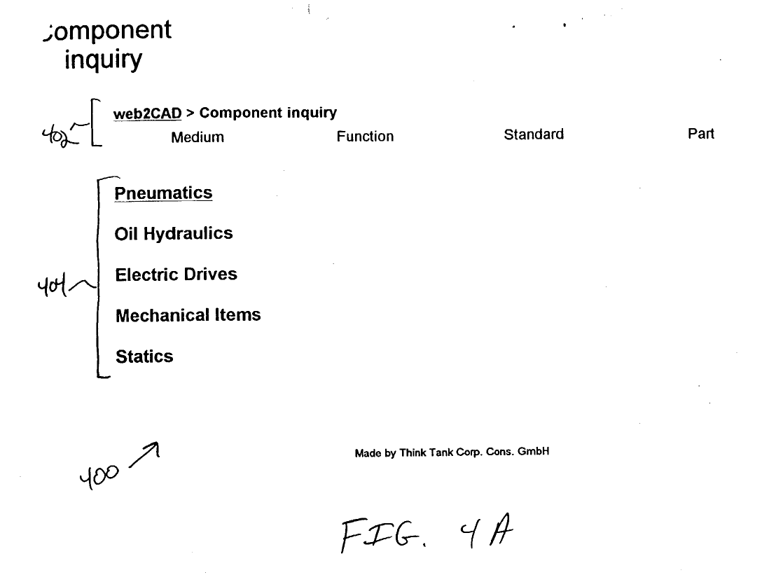

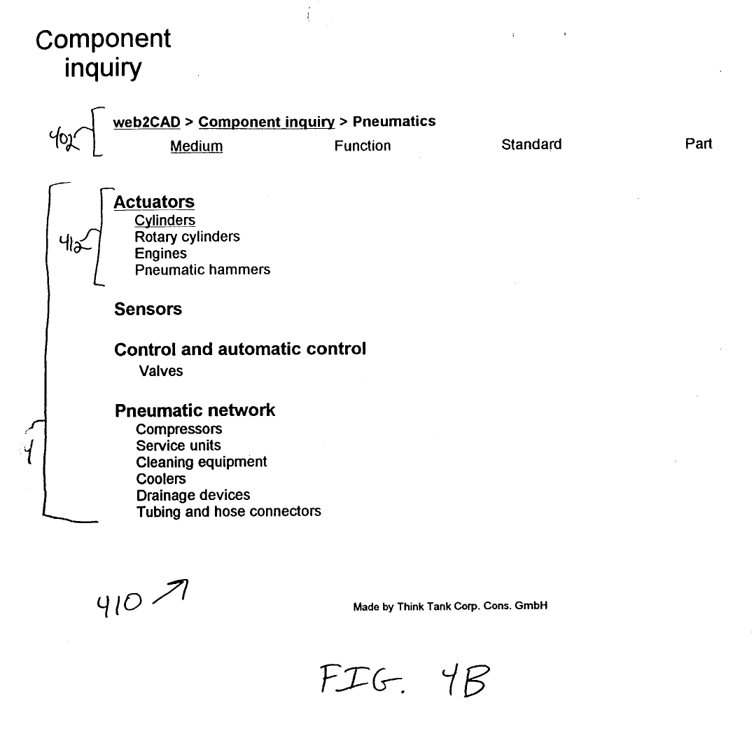

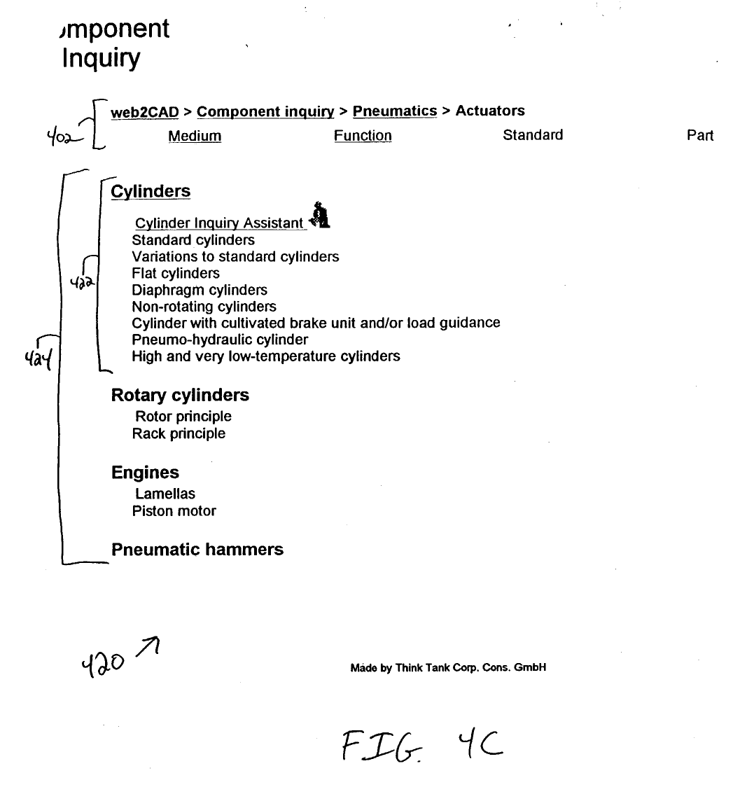

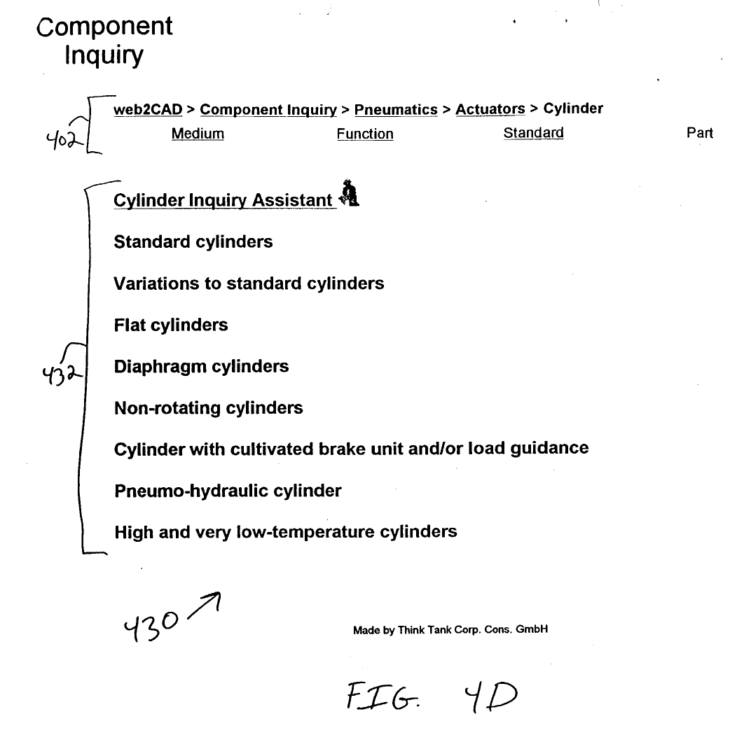

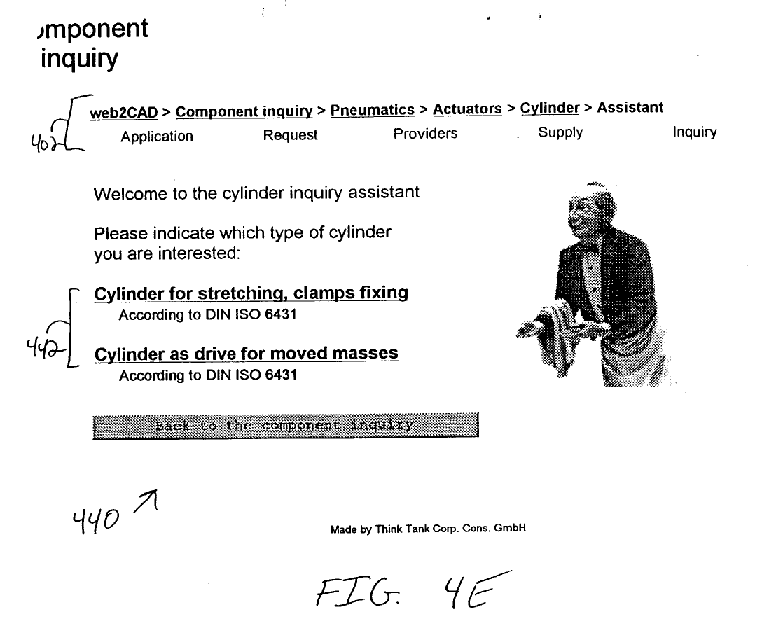

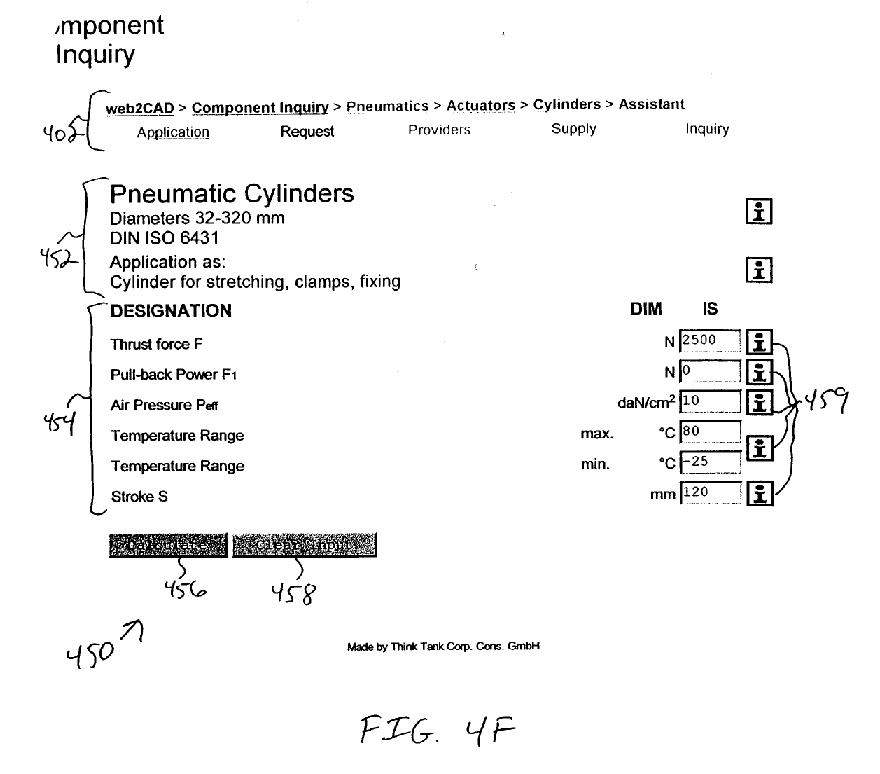

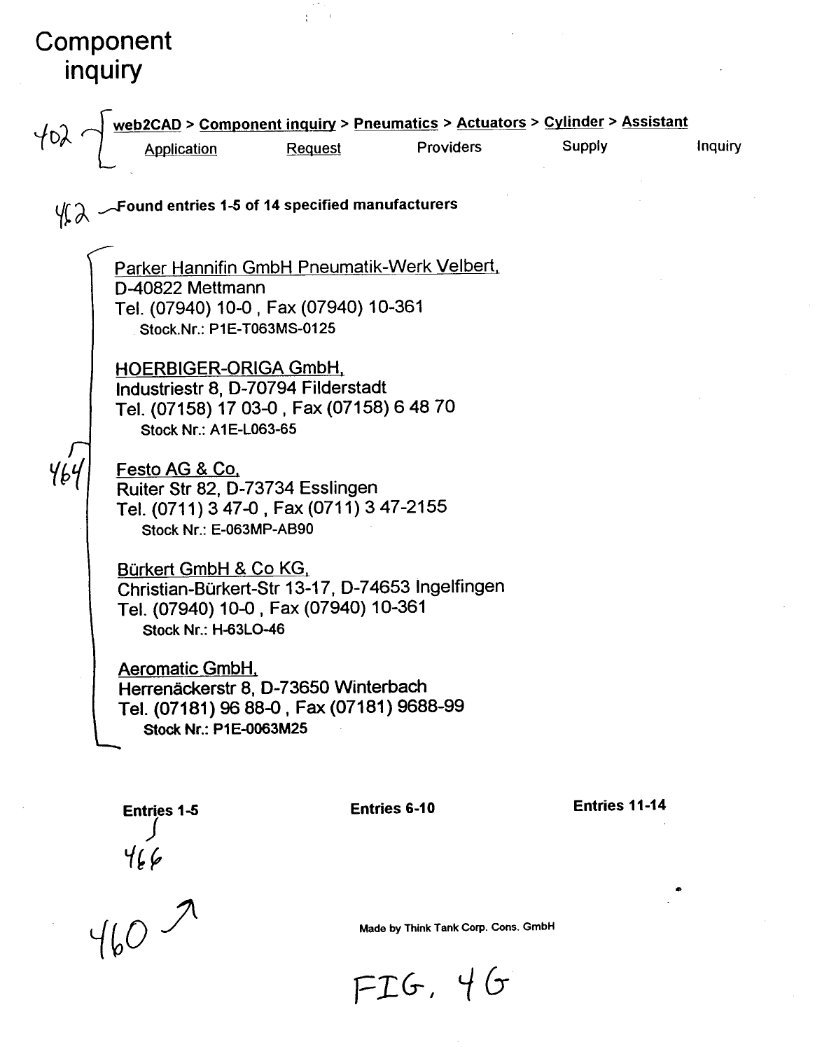

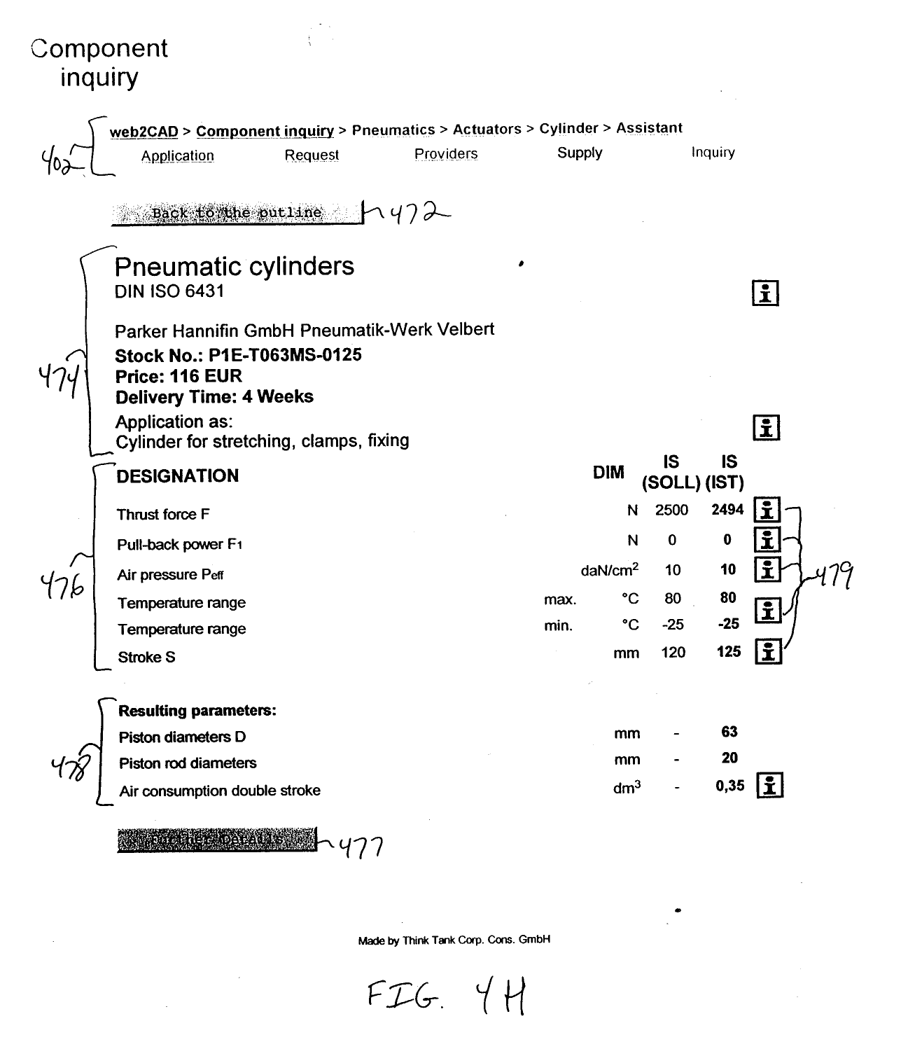

FIG. 1 is a block diagram of the hardware and operating environment in which different embodiments of the invention can be practiced. The description of FIG. 1 provides an overview of conventional computer hardware and a suitable computing environment in conjunction with which the invention can be implemented. The invention is described in terms of a computer executing computer-executable instructions. However, the invention can be embodied entirely in computer hardware in which the computer-executable instructions are implemented in read-only memory. The invention can also be implemented in client/server computing environments where remote devices that are linked through a communications network perform tasks. Program modules can be located in both local and remote memory storage devices in a distributed computing environment.

Computer 110 is operatively coupled to display device 112, pointing device 114, and keyboard 116. Computer 110 includes a processor 118 (e.g. an Intel Pentium processor), random-access memory 120 (RAM), read-only memory 122 (ROM), and one or more mass storage devices 124, and a system bus 126, that operatively couples various system components including the system memory to the processing unit 118. Mass storage devices are more specifically types of nonvolatile stored media and can include a hard disk drive, a CD-ROM drive, a floppy disk drive, an optical disk drive, and a tape cartridge drive. The memory 120, 122, and mass storage devices, 124, are types of computer-readable media. A user can enter commands and information into the personal computer 110 through input devices such as a pointing device 114 and a keyboard 116. Other input devices (not shown) can include a microphone, joystick, game pad, satellite dish, scanner, or the like. The processor 118 executes computer programs stored on the computer-readable media. The invention is not limited to any type of computer 110. Computer 110 can be a PC-compatible computer, a MacOS-compatible computer or a UNIX-compatible computer. The construction and operation of such computers are well known within the art.

Furthermore, computer 110 can be communicatively connected to the Internet via a communication device 128. Internet connectivity is well known within the art. In one embodiment, the computer includes a communication device that is a modem and corresponding communication drivers to connect to the Internet via what is known in the art as a “dial-up connection.” In another embodiment, the computer includes a communication device that is an Ethernet or similar hardware (network) card connected to a local-area network (LAN) that itself is connected to the Internet via what is know in the art as a “direct connection” (e.g., T1 line, etc.).

Computer 110 also has at least one operating environment running thereon, each desirably providing a graphical user interface including a user-controllable pointer. Such operating environments include operating systems such as versions of the Microsoft Windows and Apple MacOS operating systems well-known in the art. The invention is not limited to any particular operating environment, however, and the construction and use of such operating environments are well known within the art. Computer 110 also desirably can have at least one web browser application program running with at least one operating environment, to permit users of computer 110 to access intranet or Internet world-wide-web pages as addressed by Universal Resource Locator (URL) addresses. Such browser application programs include Netscape Navigator and Microsoft Internet Explorer.

Display device 112 permits the display of information, including computer, video and other information, for viewing by a user of the computer. Display device is also connected to the system bus 126. Speakers 113 and 114 enable the audio output of signals. Speakers 113 and 114 are also connected to the system bus 126. In addition to the monitor, computers typically include other peripheral output devices (not shown), such as speakers and printers. The invention is not limited to any particular display device 112. Such display devices include cathode ray tube (CRT) displays (monitors), as well as flat panel displays such as liquid crystal displays (LCD's). Pointing device 114 permits the control of the screen pointer provided by the graphical user interface (GUI) of operating systems such as versions of Microsoft Windows. The invention is not limited to any particular pointing device 114. Such pointing devices include mouses, touch pads, trackballs, remote controls and point sticks. Finally, keyboard 116 permits entry of textual information into computer 110, as known within the art, and the invention is not limited to any particular type of keyboard.

The computer 110 can operate in a networked environment using logical connections to one or more remote computers, such as remote computer 150. These logical connections are achieved by a communication device coupled to or a part of the computer 110; the invention is not limited to a particular type of communications device. The remote computer 150 can be another computer 110, a server, a router, a network PC, a client, a peer device or other common network node. The logical connections depicted in FIG. 1 include a local-area network (LAN) 151 and a wide-area network (WAN) 152. Such networking environments are commonplace in offices, enterprise-wide computer networks, intranets and the Internet.

When used in a LAN-networking environment, the computer 110 is connected to the local network 151 through a network interface or adapter 153, which is one type of communications device. When used in a conventional WAN-networking environment, the computer 110 communicates through a modem (not shown). The modem, which can be internal or external, is connected to the system bus 126. In a networked environment, program modules depicted relative to the personal computer 110, or portions thereof, can be stored in the remote memory storage device.

### Software Environment

FIG. 2 is a diagram illustrating a system-level overview of an exemplary embodiment of the invention. The system 200 is divided into multiple sections. The first section of system 200 is the product database 210, which includes the product information database 255 and the CAD drawings database 265. The product database stores part data, such as product data for marketing, sales and construction of mechanical component parts, which includes drawings and specification of keywords, attributes and their values. The product database uses database technology known to those skilled in the art and can execute on a computer such as system 110 in FIG. 1. The second section of system 200 is the product information source 215 which facilitates original storage and subsequent maintenance of the product database 210. The third section of system 200 is the purchasing system, indicated by the dashed lines, which includes an interactive purchasing agent component 220 which communicates with the product database 210. The interactive purchasing agent is a software component that acts as an online entities catalog and ordering process. The interactive purchasing agent is the interface between a web portal (also referred to as a web server) 290 maintained on system 200 and its deeper infrastructure such as the database 210, allowing customers and users to select items such as CAD drawings and parts; review what they have selected; make necessary modifications or additions; and purchase the items. Items can be purchased from a vendor 245, which can either be manufacturer, distributor or retailer of the component parts, or vendor 245 can be an auction site providing parts available via a bidding process. The interactive purchasing agent component 220 can execute on a computer such as system 110 in FIG. 1. Furthermore, the purchasing system of system 200 also includes an invoicing and delivery notification system 240 connected to the vendor 245 which is in turn connected to the product database 210. The invoicing and delivery notification system 240 can execute on a computer such as system 110 in FIG. 1. The fourth section of the system 200 is the product catalogue which includes product information stored on one or more data storage devices, such as CD-ROM 250. Other data storage devices having greater storage capacity can also be used to store the product information.

The fifth section of the system 200 is the CAD bank which includes CAD drawings stored on CD-ROM 260. The sixth section of the system 200 is the client computer 275 of the customer or user. The client computer 275 can execute on a computer such as system 110 in FIG. 1. The client computer retrieves requested CAD drawings 265 of mechanical products through the Internet 270 or from local CD-ROM storage 260, and retrieves requested product information 255 keywords and attributes through the Internet 270 or from local CD-ROM storage 250. The client computer 275 is also connected to the purchasing system through the Internet 270. The client computer 275 transmits bids and orders for products to the vendor 245 through the interactive purchasing agent component 220 and to the product database 210. Invoices and delivery information is communicated between the vendor 245 and the client computer 275 through the invoicing and delivery notification system 240 in which the Internet 270 communicates between the client computer 275 and the invoicing and delivery notification system 240. Therefore, the system 200, enables the client computer to receive mechanical component product drawings and specification keywords and attributes, place bids and orders of the components with the vendor, and transact invoicing and delivery with the vendor.

### Mechanical Engineering Web Portal

An initial screen 300 of a mechanical engineering web portal according to an embodiment of the invention is shown in FIG. 3. Screen 300 includes a header section 304, a left frame 302, a right frame 303, and a presentation area 320. In general, the initial screen 300 provides a variety of links to mechanical engineering functions and topics. Header section 304 can include general information, such as the title of the current page, and a news ticker 307 that scrolls current new headlines of interest to the mechanical engineering community. In addition, header section 304 can provide a search capability through the use of a search text entry box 309, and a search button 311.

In one embodiment of the invention, left frame 302 is divided into information section 305, communication section 310, and service section 315. Information section 305 provides links to pages describing universities, trade directories, trade fairs and events etc. that have associations with the field of mechanical engineering. Communication section 310 provides links of a communications nature. Included in this section are links to engineering related chat areas, Internet news groups related to engineering, a frequently asked questions (FAQ) page, a forums page, and an engineering jobs listing page. Service section 315 provides links to pages and components providing engineering services, including components provided according to various embodiments of the invention. In addition, service section 315 can provide links to auction sites that can supply parts via an on-line auction.

Presentation area 320 displays content that changes in accordance with the links that are selected in the various frames described above, such as left frame 302 and right frame 303. Initially, presentation area 320 provides various lists of engineering related news and information such as news related to mechanical engineering companies, the automobile industry (a heavy user of mechanical engineering services), and Computer Aided Design (CAD). In addition, the presentation area 320 can include links to sites related to CAD systems. For example, links are provided to the home pages of various CAD system vendors. Other links to user group pages for various CAD systems can also be provided. The initial content is replaced with link related content as a user make selections from the links contained in the various frames of initial screen 300. The specific link related content is described in further detail in the sections below.

Those of skill in the art will appreciate that the description of initial screen 300 provided above and the screen formats described below are examples of possible screen layouts, and that other screen formats providing similar information are possible. The invention is not limited to the particular formats described.

### Electronic Search Assistant and Search Engine

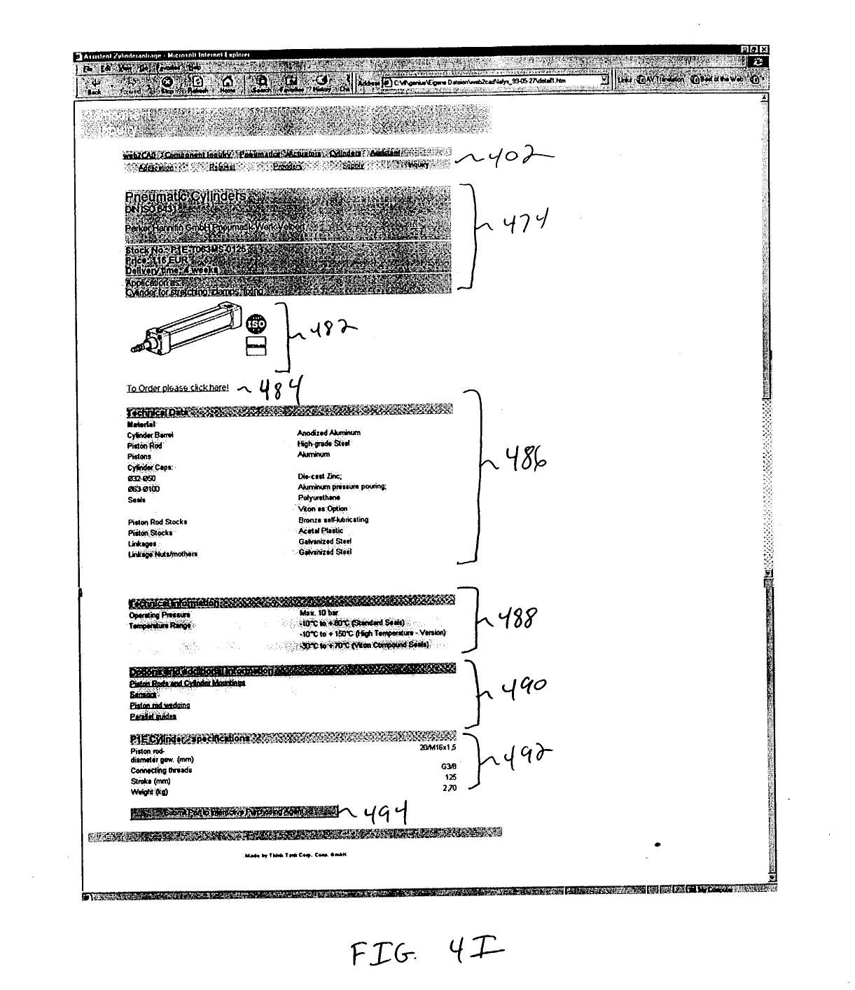

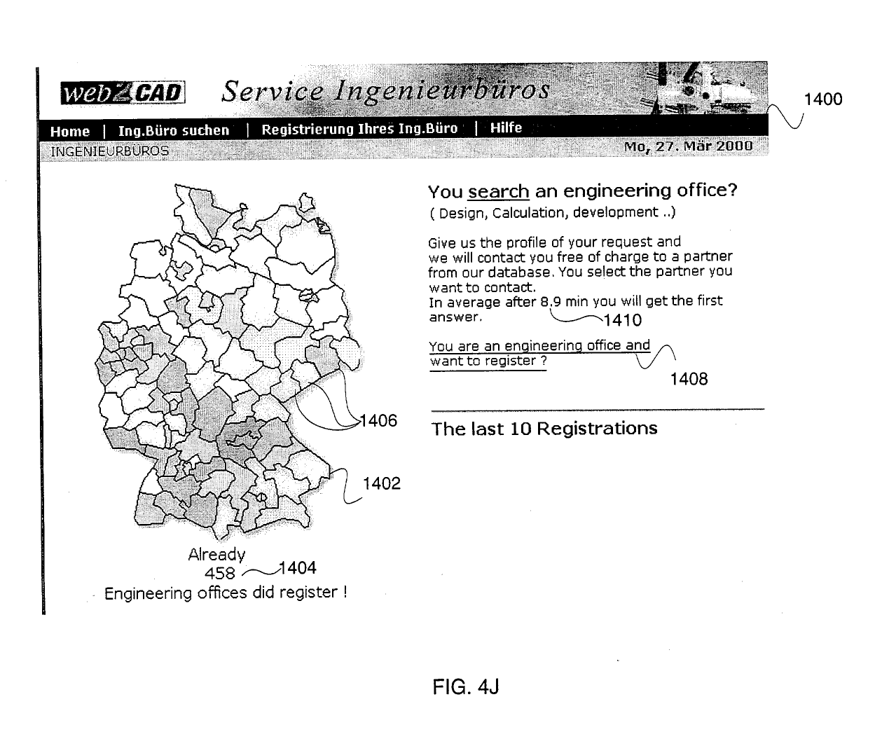

Mechanical engineering projects typically require that a design engineer choose the component parts that will be assembled as part of the project. The component parts may be custom designed, or they may be off-the-shelf products. A wide variety of choices are available for the off-the-shelf products, and knowing what products and manufacturers can provide a product can be a difficult task. Furthermore, different parts have different characteristics, tolerances, capabilities, and specifications to choose from. FIGS. 4A-4I describe an electronic search assistant and search engine according to an embodiment of the invention that assist the designer in choosing component parts.

The search assistant is initiated by selecting an appropriate link from the initial screen 300 (FIG. 3). The presentation area 320 is then updated to display initial component inquiry screen area 400 with content illustrated in FIG. 4A. Screen area 400 includes an inquiry header 402 and a component list 404. Inquiry header 402 provides information regarding where, in a hierarchy of content areas, the current content area lies. In one embodiment of the invention, inquiry header 402 includes a first line indicating the hierarchy of previous selections, and a second line that provides a generic description within the hierarchy. The generic description can be displayed as a link to a previous point in the hierarchy. Component list 404 provides a list of candidate general component types that can be selected by the user for further inquiry. The list of component types is provided for illustrative purposes, and no embodiment of the invention is limited to the particular component types shown in FIG. 4A.

As an example of the operation of an embodiment of the invention, consider the case where a user has selected the “Pneumatic” option from component list 404. In this case, the presentation area 320 is updated to show a function inquiry screen area 410 as shown in FIG. 4B. The inquiry header 402 is updated to reflect the new area by adding the parent screen area (i.e. screen area 400) to the screen selection hierarchy. In addition, the word “function” is highlighted on the description line to indicate that the user is currently in a function selection mode.

Screen area 410 also includes a function list 414. Function list 414 comprises a list of general functions that can be performed by the components within the component type selected from component list 404 (FIG. 4A). In certain cases, functions can be further subdivided into one or more sub-functions, in which case a sub-function list 412 can be presented in screen area 410. In the exemplary embodiment, the function list comprises a set of functions that can be performed by pneumatic components. For example, a pneumatic component can be an actuator, a sensor, a control, or a part of a pneumatic network. The user selects the function from the list provided that the component is to perform. As those of skill in the art will appreciate, the list of functions provided in function list 410 (and possibly sub-function list 412), will depend on the component type previously selected. Differing component types will necessarily have differing functions and sub-functions. The invention is not limited to any particular function or sub-function.

To further illustrate the operation of the exemplary embodiment, assume that the user has determined that a pneumatic actuator is required. FIG. 4C illustrates a standard screen area 420 according to an embodiment of the invention that is displayed when the user selects the “Actuator” link from function list 412. The standard screen area 420 includes inquiry header 402, component standards list 424, and component standard parts list 422. The first line of the inquiry header 402 is updated to illustrate the current page's position in the hierarchy of screen areas. The second line is also updated, reflecting the fact that the user is now selecting a standard type of component for performing a particular function.

Component standards list 424 provides a list of standard component types that perform the function previously selected by the user. In the current example, the standard component types includes cylinders that perform actuating functions, including standard cylinders, rotary cylinders, engines, and pneumatic hammers. The standards list can further include parts list 422, which provides a listing of part types that are included in the standard component types. Included in the parts list 422 is a link to an inquiry assistant web page. The function of the inquiry assistant will be described in further detail below with reference to FIG. 4E.

The standard component types illustrated in FIG. 4C are one example of a particular type of component, namely a cylinder component. Those of skill in the art will appreciate that the standard component types presented in component standards list 424 and in parts lists 422 will depend on the selections performed by the user, and that the invention is not limited to any particular component standard or component part.

FIG. 4D shows an exemplary parts screen area 430 according to an exemplary embodiment of the invention. The parts screen area 430 shown assumes that the user has selected the “cylinder” link from the component standard list 424. Parts screen area 430 includes inquiry header 402, which like the previous screen areas described, is updated to reflect the current screen area's position in the screen area hierarchy. The second line of header 402 is updated to reflect that the user is in the parts selection screen. Also included is parts list 432. Parts list 432 provides part types that are included in the standard components that perform the function as selected by the user on previous screen areas. In the current example, a list of parts that are cylinders that perform an actuating function are included in parts list 432. Also included in the list is a link to the inquiry assistant web page. In the example shown in FIG. 4D, the inquiry assistant link invokes a cylinder inquiry assistant, however the particular inquiry assistant included in the list will depend on the component types and finctions previously selected by the user.

The initial display frame 440 of an exemplary inquiry assistant is shown in FIG. 4E. The display frame 440 includes a header 402 and component application list 442. In the exemplary embodiment, the first line of header 402 is updated to reflect the inquiry assistant's position in the hierarchy of frames selected by the user, and the second line has an entry highlighted to indicate that the assistant is in application selection mode. Component application list 442 provides a list of applications in which the component part is to be used. It is desirable lo provide such a list, because the inquiry assistant can narrow the domain of potentially applicable parts to those that are suitable based on the intended application for the part. In the cylinder example illustrated in FIG. 4E, two applications for pneumatic cylinders are presented, those in which the cylinder is used to stretch an object that is fixed, and those applications in which an object is moved.

Upon selection of an appropriate application for the part, a request frame 450 is displayed to the user in presentation area 320, as illustrated in FIG. 4F. The request frame includes header 402, component data 452, component parameters 454, and action buttons 456 and 458. Header 402 is updated to show that the user has moved from application selection to request mode by highlighting “request” in the second line of header 402. Component data 452 provides information of a general nature, including the range of certain parameters associated with the component part, any industrial standards related to the part, and the intended application for the part.

Component parameters 454 provide a mechanism for a user to enter parameters for various conditions that the component must satisfy. In the exemplary embodiment, the parameters are presented in a table that provides the name or designation for the parameter, the units of measurement (dimension) for the parameter, and a value for the parameter. For each parameter, the user enters a desired value. Also associated with each parameter is an information button 459. If information button 459 is pressed, for example by pointing and clicking on the button, a text window is displayed giving the user further information regarding the parameter.

In the exemplary embodiment, action buttons 456 and 458 are provided. Action button 458 is an input delete button. Pressing action button 458 causes the current parameter values to be reset to zero, allowing a user to start over with fresh values. Pressing action button 456 causes the client computer to submit the parameters to a search engine on a server hosting the portal. The search engine then uses the supplied parameters and selection criteria based on the user's selection on previous pages to determine which, if any, vendors can supply parts that meet the user's needs.

In an alternative embodiment of the invention (not shown), the interface shown in FIG. 4F includes buttons or menus to that direct the search to particular types of vendors. For example, one button, icon or menu can cause the search parameter to be submitted to a search engine that searches for manufacturers, distributors and retailers that can supply the part. A second button, icon or alternative menu choice causes the search parameters to be submitted to a search engine that searches auction data for matches to the parameters. The search engine can search auction data maintained by the portal provider, or the search engine can search known on-line auction sites for matches to the search parameters.

An exemplary providers frame 460 is shown in FIG. 4G. The providers frame 460 includes the inquiry header 402, an entry count 462, a providers list 464, and navigation buttons 466. The inquiry header is updated to show that the user is on the providers page by highlighting the word “providers” in the header. Providers list 464 displays a list containing details about the providers that can supply a part meeting the user's criteria. The detail list can be ordered by any one of a number of different criteria. For example, the list can be ordered by price, delivery time, or by how well the part matches the user's input criteria. These details can include the address, telephone number, price, delivery time, part number and other information pertaining to the matching part. If more providers are discovered than can fit on a single page, the providers list 464 comprises a subset of the total list of providers. Entry count 462 provides the total number of providers that can supply parts meeting the user's criteria, and which entries of the total list are currently displayed in providers list 464. The user can navigate through the total list of providers by selecting one of navigation buttons 466, which causes the display to be updated with the provider entries indicated on the button 466. Each entry in providers list 464 is selectable. Upon selection, details regarding the vendor's part are shown.

In an alternative embodiment of the invention, the providers list shown in FIG. 4G can be a list of entities that can supply the part via an auction process. The entities can be read from auctions maintained by the web portal provider, or they can be links to on-line auction web sites that offer the specified parts for bidding.

A representative supply detail frame 470 is presented in FIG. 4H. Supply detail frame 470 includes the header 402, vendor data 474, part parameters 476, resulting parameters 478, and button 477. Header 402 is updated to show that the current page is the supply frame by highlighting the word “Supply” in the header. Vendor data 474 includes the vendor's name, address, the vendor's part number for the selected part, the price of the part, the delivery time for the part, and the intended application for the part. The information presented can also include whether or not the vendor has the ability to fabricate or modify standard parts.

In one embodiment of the invention, part parameters 476 are presented in a table having four columns. A first column provides the parameter's name or designation, the second column provides the unit of measurement, or dimension for the parameter, the third column provides the parameter value entered by the user in table 454 (FIG. 4F), and the fourth column provides the parameter value for the part as assigned by the vendor or manufacturer. The search engine employs algorithms capable of finding both exact matches, and close matches to the parameter values entered by the user, thus the user's value and the vendor's value do not always match exactly.

Resulting parameters 478 provide the user with values that are calculated or derived based on the input parameters and the vendors part data maintained in database 210. The resulting parameters displayed will vary depending on the component part selected. In the example shown in FIG. 4H, the piston diameter, piston rod diameter, and the air intake of the cylinder are calculated and displayed to the user.

Each of the parameters in part parameters 476 and resulting parameters 478 can have an additional information icon 479 associated with it. Upon pressing a particular icon 479, additional information regarding the parameter is displayed to the user.

Supply detail frame 470 also includes a further details button 477. When pressed, button 477 causes the portal web server to send further part data to the client web browser. An exemplary part detail frame 480 containing this detail is shown in FIG. 41. Part detail frame 480 includes inquiry header 402, vendor data 474, part drawing 482, order button 484, technical data 486, option information 490, part specifications 492 and placement button 494. Inquiry header 402 is updated to reflect that the current page is an inquiry page by highlighting the word “Inquiry”. Previous pages are shown as links in the header 402. Part drawing 482 provides an image of the currently selected part. In an alternative embodiment of the invention, a CAD drawing of the part is displayed. The choice of whether to display an image or a drawing of the selected part will be determined by the speed of the search engine, and the network speed and bandwidth available to transmit the image or drawing. Technical data 486 provides information such as the composition of the component elements of the part. Technical information 488 provides information including minimums and maximums for various aspects of the operating environment in which the part is to be placed. Option information 490 provides links to enable the user to obtain information on related parts and components that are commonly used with the selected part. Part specifications 492 provides data regarding the dimensions and weight of the part. The data in the various sections 486, 488, 490 and 492 can vary from part to part, and from vendor to vendor. The invention is not limited to any particular placement or specific content for the data.

In one embodiment of the invention, clicking on order button 484 causes an order to be generated for the part In this embodiment, the database 210 provides a “virtual warehouse” of parts data. The data maintained in the virtual warehouse includes part identification information such as a stock number, available quantity, and guaranteed delivery time for the part. The client transmits the order event to the portal provider, which deducts an ordered quantity from currently available quantity at the current guaranteed delivery time. The portal generates an order for the part that is sent to the vendor. The order can be transmitted electronically via the Internet, it can be sent via electronic mail (e-mail), it can be sent via fax, or it can be printed and mailed to the vendor.

In an alternative embodiment of the invention, the part can be submitted to an interactive purchasing agent. The operation of the interactive purchasing agent is described in further detail in the next section.

The search process has been described above in terms of a series of frames that provide part selection options to a user that lead to a search results frame. However, in a further alternative embodiment of the invention, a database of parts, such as database 210 and be queried using a text based search. In this embodiment, parts are identified by names that generically describe the part. In addition, the parts have attributes types, each type having an attribute value. For example, a part named “pneumatic cylinder” can have attribute types comprising the diameter of the cylinder, and the stroke of the cylinder. The user then inputs keywords identifying the part name, and one or more attribute type and value pairs. The search engine then produces a results frame 460 as in FIG. 4G identifying vendors that supply parts meeting the indicated search criteria. In a still further embodiment of the invention, the search engine produces a list of parts that meet the search criteria.

In the examples discussed above, the search criteria comprised aspects of the physical dimension of the part, for example, the physical dimensions of a cylinder. However, the invention is not limited to such search criteria and other search criteria comprising the physical environment for the part can be entered instead of, or in addition to, the criteria discussed above. For example the user may know the mass of an object to be moved and the velocity that must be achieved. The user can enter the mass and velocity, and the search engine determines the attributes of a part that can perform according to the search criteria. To illustrate, the user may need to move 50 kg, on a stroke with 100 mm in 2 sec. The user enters the appropriate criteria, and the search engine will provide a list of parts that meet the criteria.

In addition, the examples presented above have been directed to identifying vendors selling parts that meet the user's search criteria. However, the invention is not limited to identifying vendors based on the ability to supply parts. In yet another embodiment of the invention (not shown), the electronic search assistant and search engine are used to identify vendors that can supply a service. In this embodiment, a customer (also referred to as a job source) provides bid conditions regarding the service to be performed. These bid conditions can include the description of a part (either text or graphics), a quantity desired, a supplier location, a part size, a machine type and a supplier size. In addition, the bid conditions can include commercial terms, such as warranties and remedies provided by a supplier. A search engine component of the portal server then searches a database that includes supplier data, such as database 210 (FIG. 2) for suppliers that can meet the bid conditions.

FIG. 4H illustrates an exemplary screen 1400 according to an embodiment of the invention in which a user can specify a geographic area to conduct the search. Screen 1400 includes map 1402, registration link 1408, service provider count 1404, and average response answer time 1410. Map 1402 provides a geographic entity from which a user can select sub-entities 1406. For example, the geographic entity can be a continent and the sub-entities can be countries on the continent. Alternatively, the geographic entity can be a country, and the sub-entities can be states, provinces, or other political or geographic sub-divisions of the country. The invention is not limited to any particular entity/sub-entity combination.

A user can select the sub-entities to restrict the field of search to those service providers that have offices in the selected sub-entities.

Service provider count 1404 indicates the number of service providers that are registered in database 210. The count can include all the service providers registered in the database, the number of service providers in the selected sub-entities, or the number of service providers that can provide services that can potentially meet the input bid conditions.

Average response time 1410 provides an indication of the time in which a user can expect a response to their request. The average time shown can be averaged over all services registered in database 210, for those services in the selected region, or for those services that can meet the input bid conditions.

Registration link 1408 provides an interface for service providers to register with database 210.

In one embodiment of the invention, portal server 290 (FIG. 2) then submits a request to bid to each of the suppliers meeting the bid conditions. The request to bid will include the part description supplied by the customer. The supplier can then respond to the request to bid if it wishes to do so. Upon receiving a bid from a supplier, the portal server bills the customer a predetermined amount for handling the bidding process.

In an alternative embodiment of the invention, a list of service providers that can meet the bid conditions within the selected geographic area are displayed to the user via a web page (not shown). The user can then select one or more of the service providers that the user desires to send the requested part description to. The invention is not limited to any particular manner of selection, examples include checking a box on the web page, clicking a button on the web page, selecting a link representing the service provider.

After the desired service providers have been selected, the system causes request data to be sent to the selected service providers. In one embodiment of the invention, the service provider is notified of a request via an e-mail to the service provider. The e-mail can direct the service provider to a web page providing the request data, including the desired part description and parameters associated with the desired part. The service provider can then either indicate they would like to respond to the request, or decline to respond to the request. If the service provider desires to respond, the system, in one embodiment of the invention, generates an e-mail to the requesting user identifying the service provider to the requesting user.

In some embodiments of the invention, the identity of the requesting user can be withheld, allowing users to make anonymous requests.

Also, some embodiments of the invention allow additional parts data to be provided as an attachment to the request. In some embodiments of the invention the requesting user can control which providers can read or view the attachments to the request.

As can be seen from the above, in some embodiments of the invention, the system acts as a “middle-man” between the requester and the service provider. This allows the system to track and provide useful data to both service requesters and service providers. For example, the system can track the time it takes for a supplier to respond to a request, the number of requests a service provider receives, the number of requests a service provider responds to, whether or not the requester and provider stay in contact. The above data can then be stored in database 210.

In further embodiments of the invention, the response time data described above can be used to provider system users with useful information. For example, users can be provided a time by which a service provider will respond to a request. In addition, service providers can be classified according to the amount of time they take to respond to requests. Furthermore, the data can be used to monitor whether or not service providers a meeting response time guarantees.

In some embodiments of the invention, the service provider must pay a fee in order to be registered with the portal provider. The fee can be a one-time fee, or a fee based on a period of time, for example an annual fee. In addition to, or instead of the fees described above, the service provider can be charged a fee for each request received and/or responded to by the service provider. Furthermore, the system can provide an interface for a user to mark a particular request as urgent. In this case, the system can charge the service provider an additional fee. The additional fee represents the additional value the system provides to the service provider by the information that there is some pressure to close a deal on the part of the requesting user.

In both the parts example and the services example discussed above, the search criteria can include price and delivery terms. For example, the user can search for parts and/or services by entering parameters indicating the user wants parts or services at the lowest price that can be delivered by a particular date.

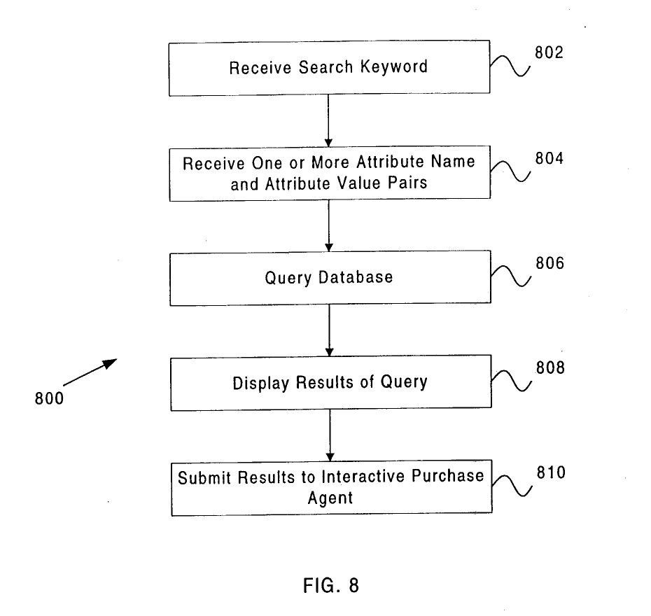

A method 800 for searching a database for one or more parts is illustrated in FIG. 8. The method can be performed by computer programs made up of computer-executable instructions. Describing the method by reference to a flowchart enables one skilled in the art to develop such programs including such instructions to carry out the method on suitable computers (the processor of the computer executing the instructions from computer-readable media). The method illustrated in FIG. 8 is inclusive of the acts required to be taken by an operating environment executing an exemplary embodiment of the invention.

The method begins when the system receives a search keyword. The search keyword can be the name for a part, for example “cylinder” (block 802). The keyword can be received as the result of a user selecting a keyword from a web page, such as page 410 (FIG. 4B) or the keyword can be entered as text to a search engine. Next, the system receives one or more attribute name and attribute value pairs (block 804). The attribute name and attribute value pairs represent characteristics of the entity associated with the keyword. For example, the attributes associated with a cylinder include the bore, and stroke of the cylinder. In addition, the attributes can represent environmental characteristics of the entity. For example, the mass and the distance that an object is to be moved by the entity. The system uses the environmental characteristics to calculate the physical characteristics that the entity must have in order to operate given the environmental characteristics. The attributes can be entered via a text box on a web page, as described above, or they can be entered as search text to a search engine.

The system then queries a database of part information, such as database 210 (FIG. 2) for parts that match the input keyword and attributes (block 806). A list of matching parts is returned and displayed to the user (block 808). The list of can comprise a list of vendors that can supply the part, or the list can comprise the list of parts itself. In one embodiment of the invention, the list is displayed as a web page.

Next, upon selection of a part by a user, the system submits an order for the part, for example by submitting the part to an interactive purchasing agent component of the system (block 810). The interactive purchasing agent component is described in further detail in the next section.

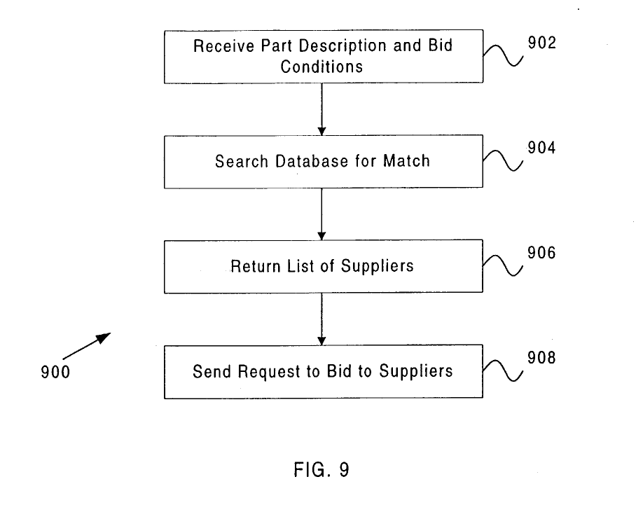

In FIG. 9, a method 900 is shown in which a database is searched for supplier information. The method begins when the system executing the method receives as input a part description and bid conditions associated with the part (block 902). The input can be provided by a user entering search criteria and bid conditions on fields of a web page, or the input can be provided as a command line to a search engine. The part description can be a part name such as a cylinder. The bid conditions can include one or more conditions such as guaranteed delivery time, quantity, supplier location, supplier size, guarantee offered, or other conditions associated with the purchase of a part. For example, the bid conditions may specify that a supplier must be able to deliver a minimum quantity of 100 cylinders within four days. The system then searches a database of parts and parts suppliers, such as database 210, for suppliers that can meet the input bid conditions (block 906). In one embodiment of the invention, the list is returned on a web page.

Next, the system sends a request to bid to the list of suppliers that can meet the bid conditions (block 908). The system can use a variety of methods to send the bid request, including e-mail, fax, and printing a bid request to be mailed to the supplier. In addition, the system can place the bid request on a web page to be viewed by the supplier.

In an alternative embodiment of the invention (not shown), the user is charged a commission upon the selection of one of the suppliers responding to the bid request generated by the system.

The above described methods have been described in the context of a search for a cylinder, however the invention is not limited to searches for any particular type of part, as those of skill in the art will appreciate.

### Interactive Purchasing Agent

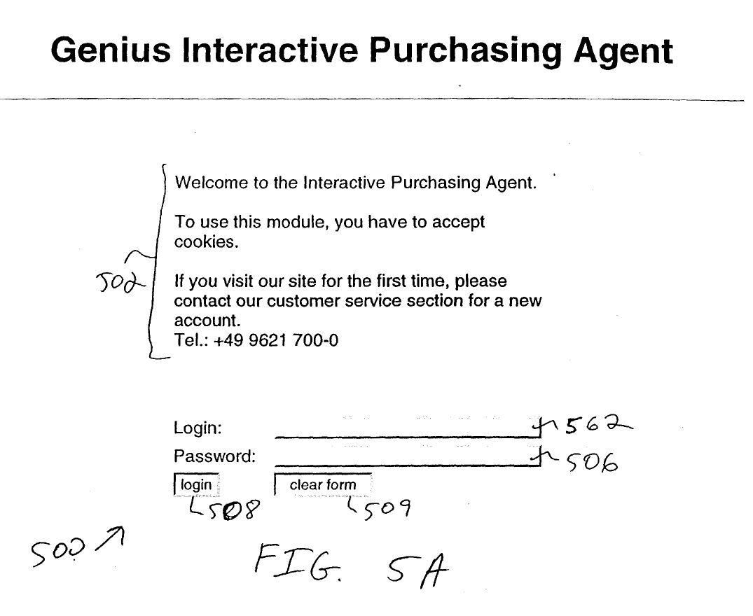

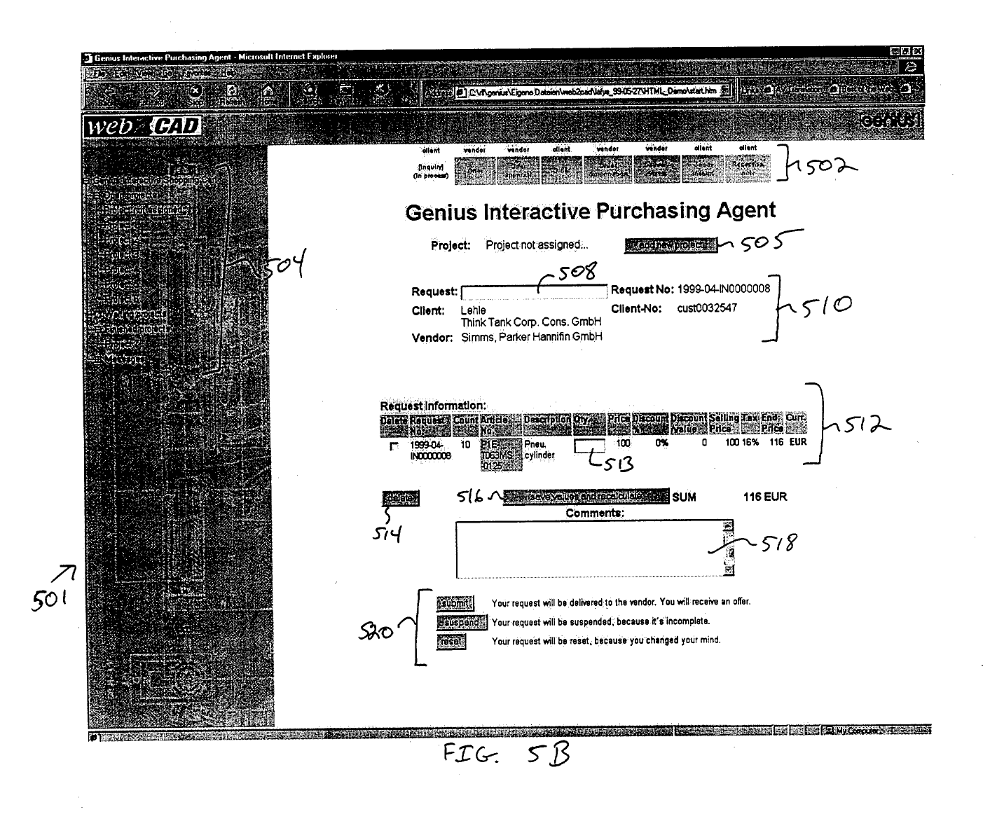

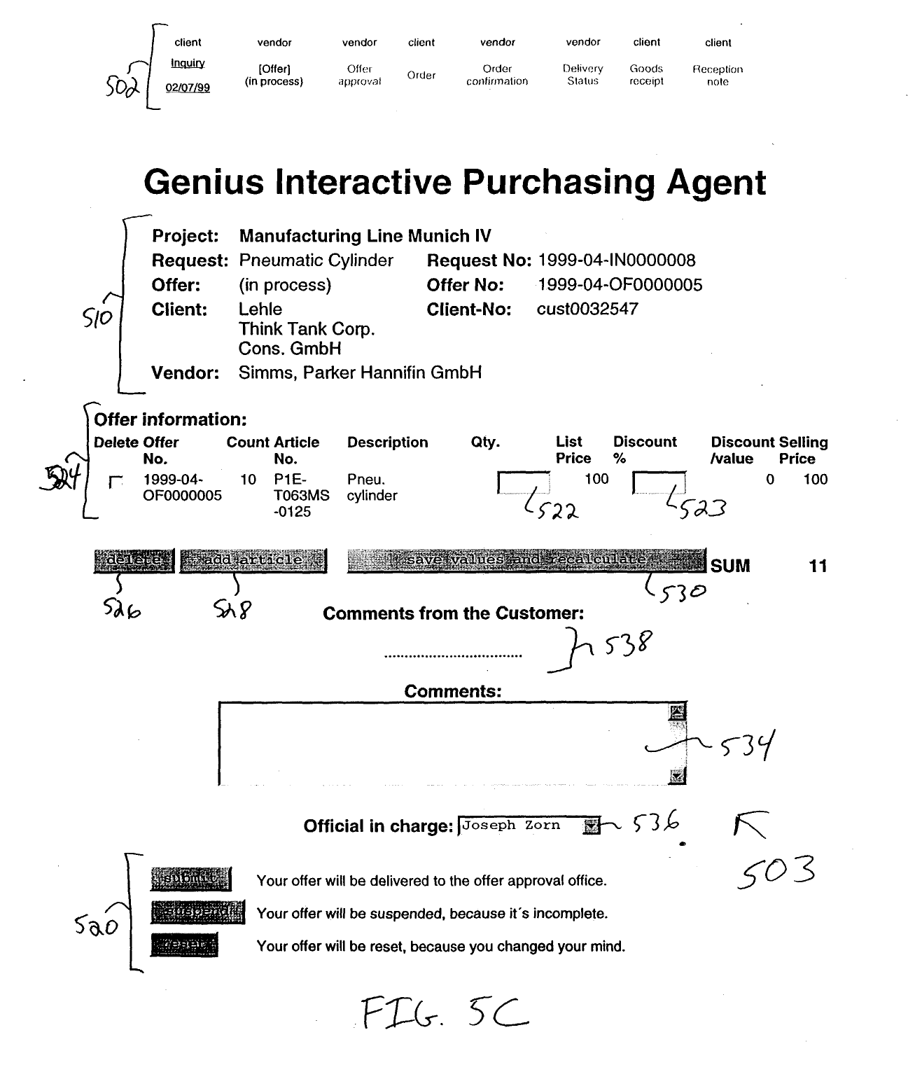

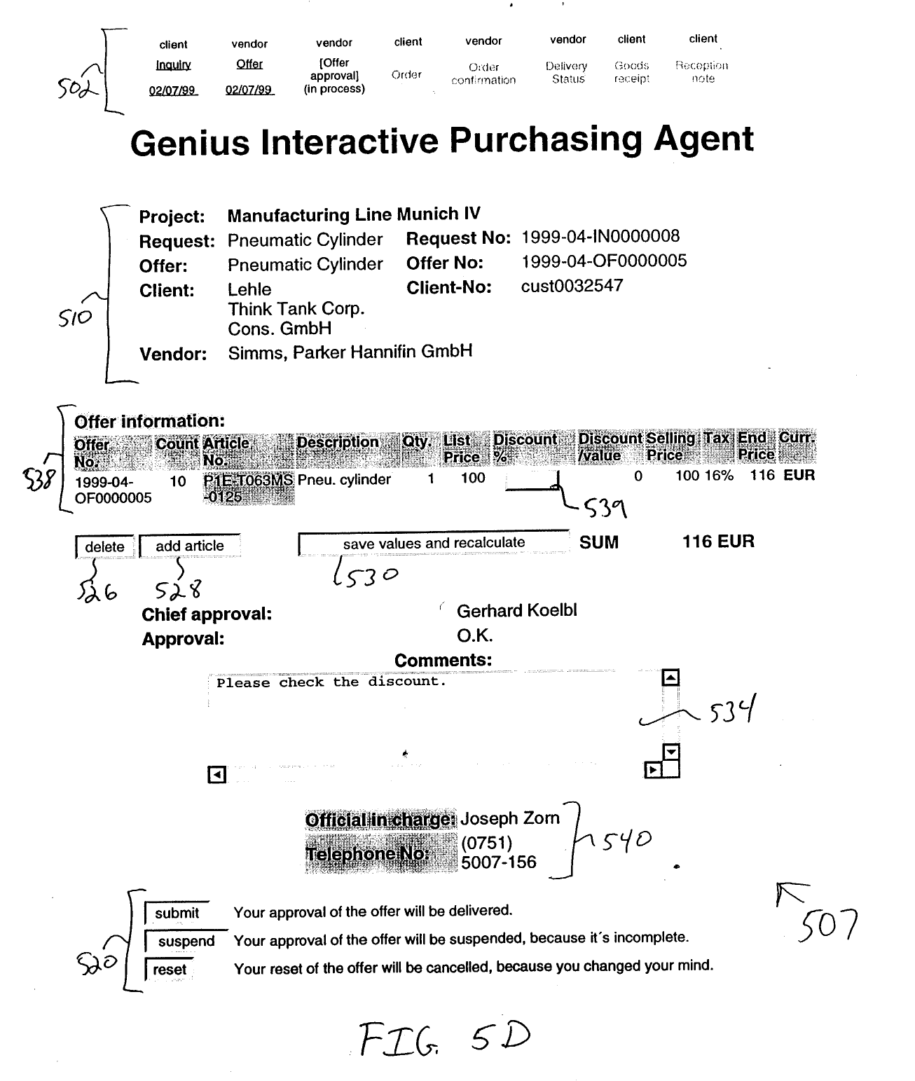

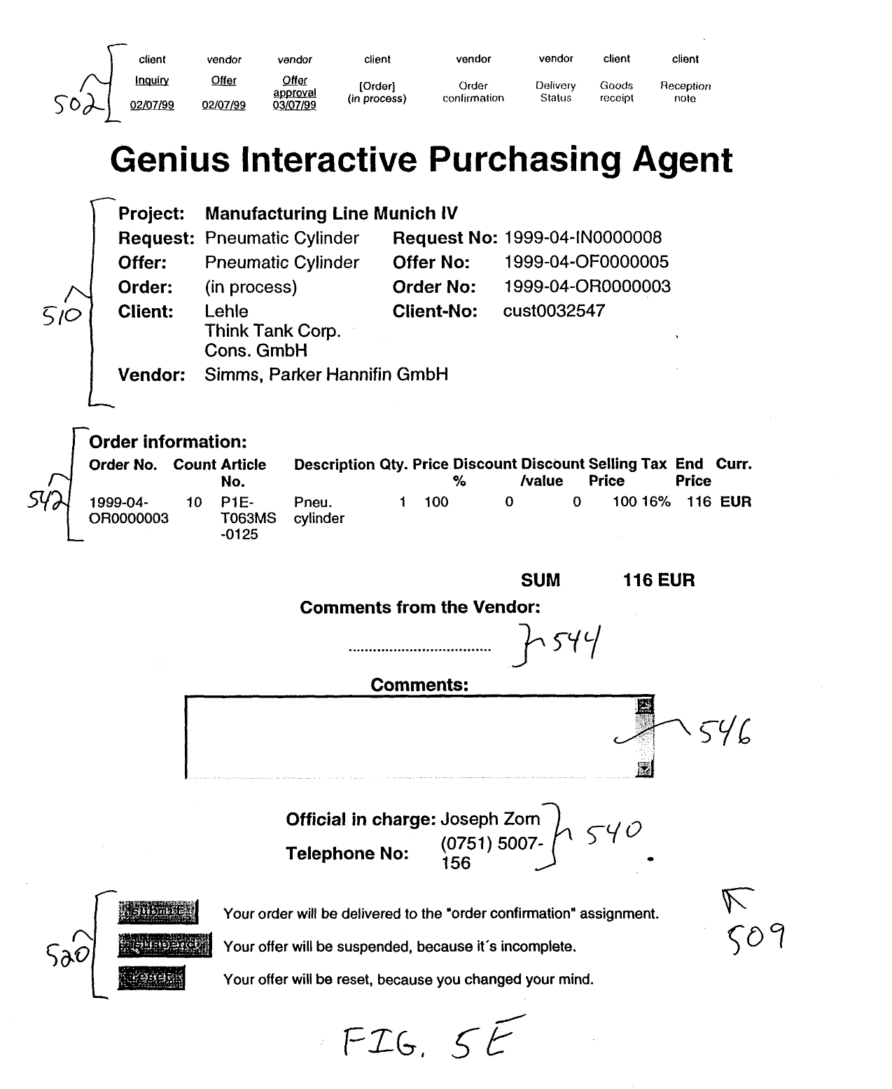

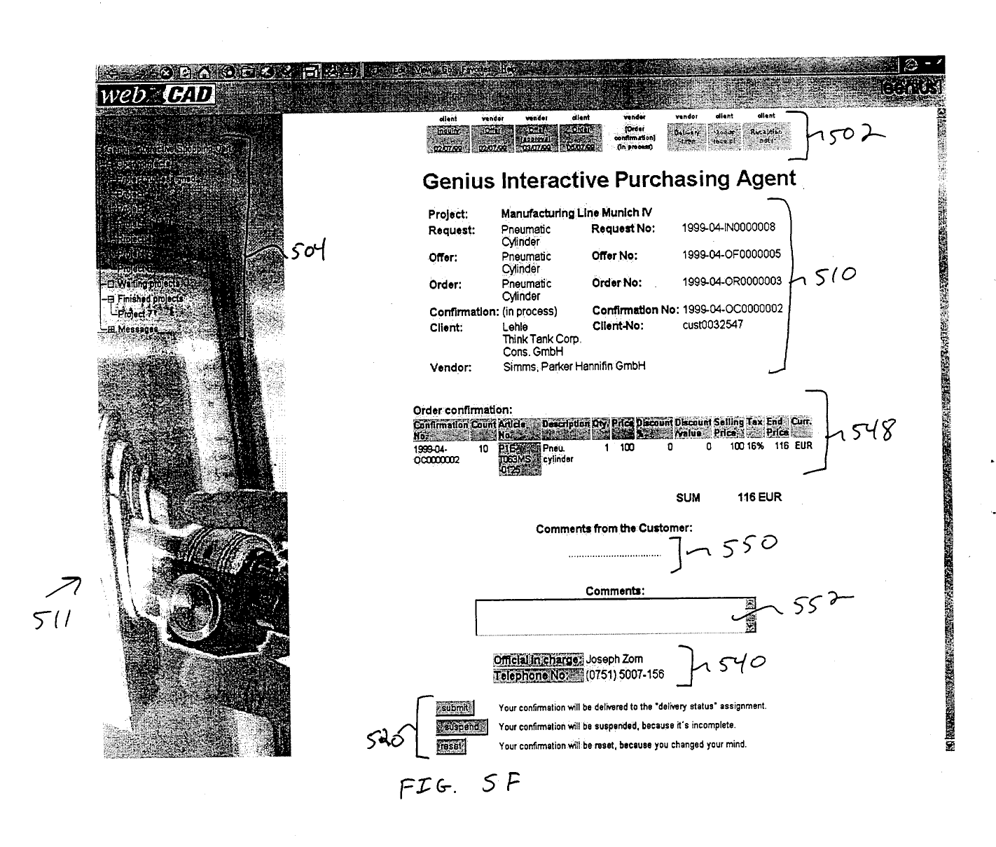

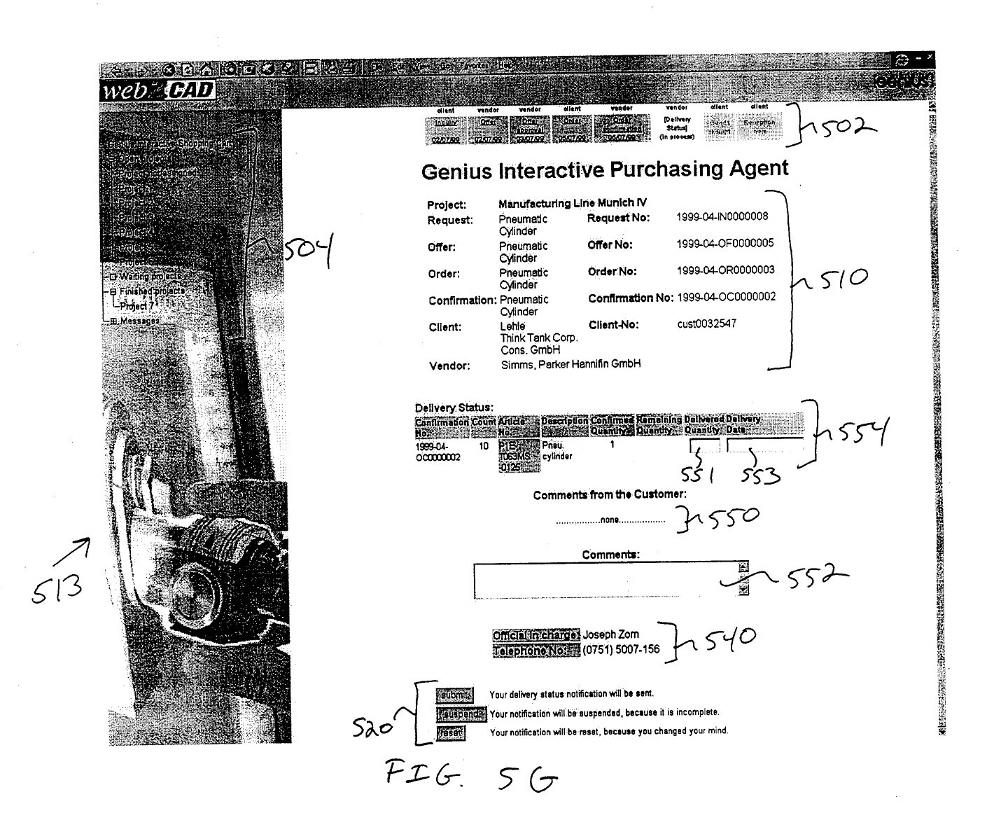

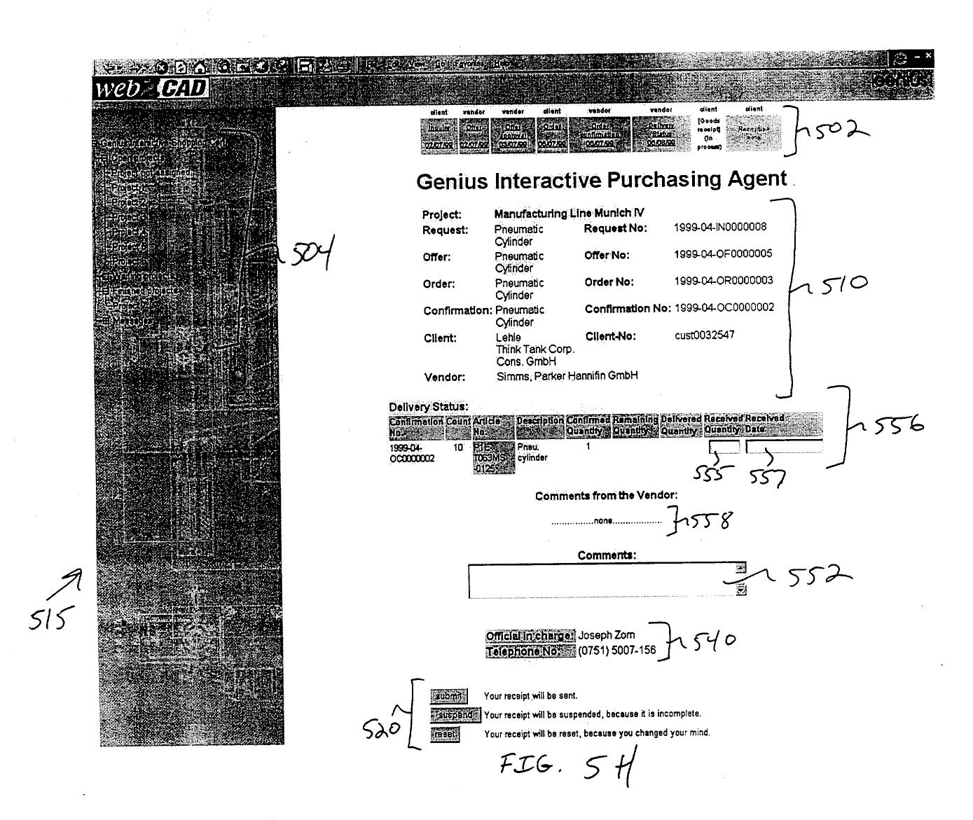

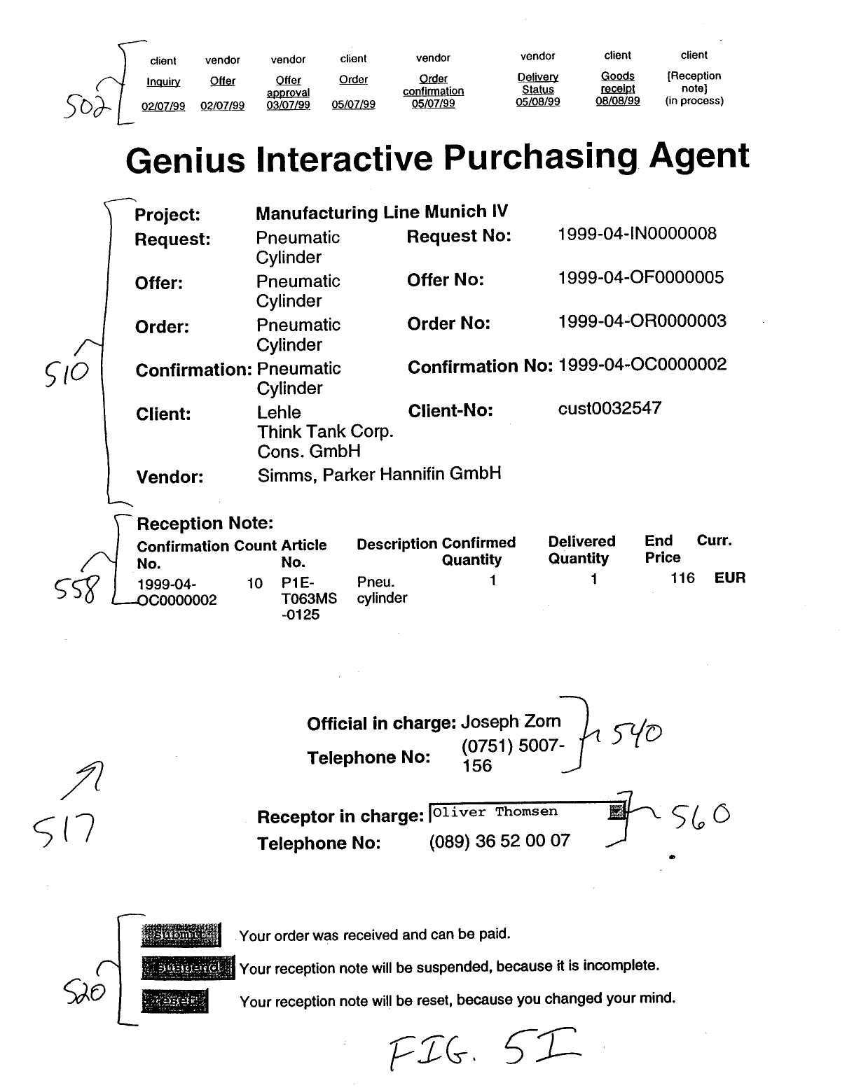

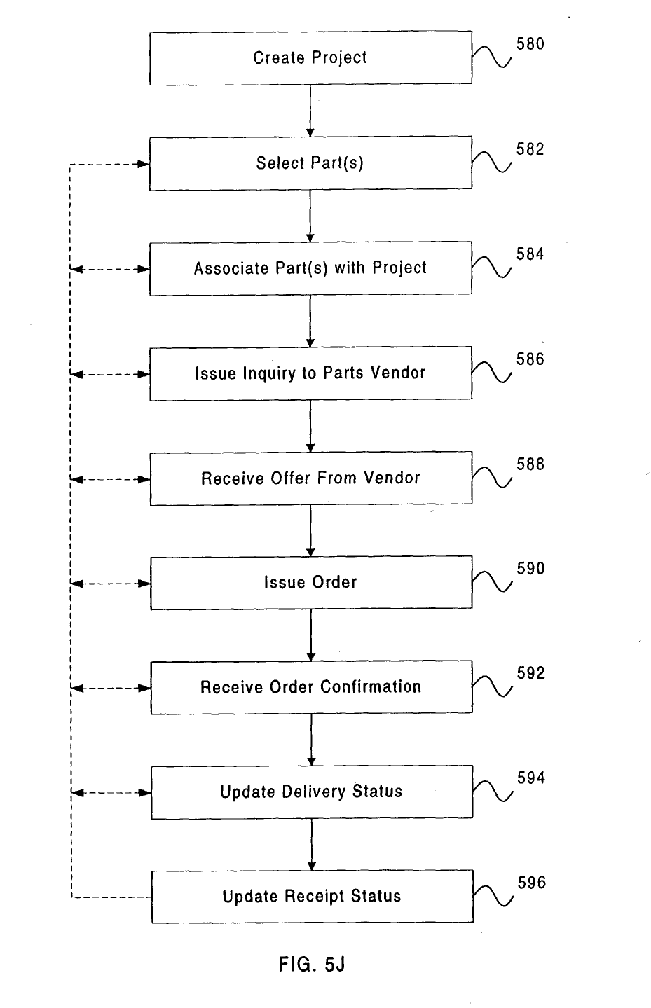

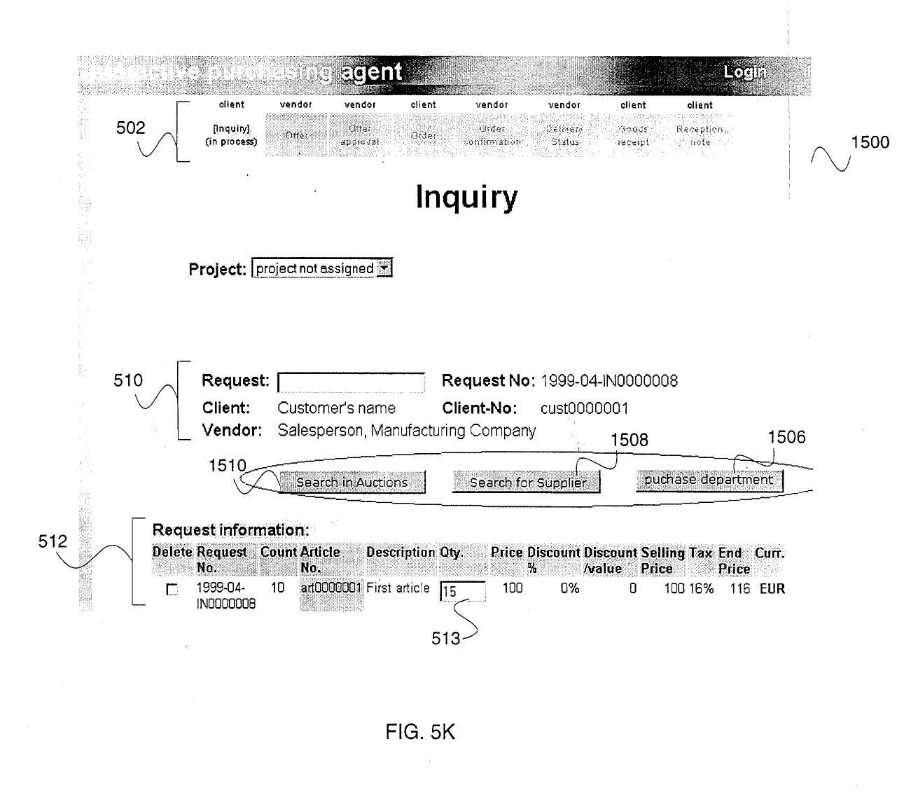

Another aspect of the mechanical web portal according to an embodiment of the invention is an interactive purchasing agent (IPA). It is common for mechanical engineers and other designers to require various parts for assemblies. In addition, it is common for an engineer to be working on multiple projects at a time, with each project being in a different state of completion with respect to the parts ordered and acquired. The electronic purchasing agent according to an embodiment of the invention provides a system for easily maintaining the acquisition status of parts associated with one or more projects. The operation of the IPA according to an embodiment of the invention is illustrated in FIGS. 5A-5I, which illustrate frames of web pages presented by the system to an end user. 0

An exemplary security frame 500 is shown in FIG. 5A. The security frame 500 includes informational text 502, login text area 562, and password text area 506. The IPA provides security to prevent unauthorized persons from accessing client data that can reside in portal database 210. Thus, in order to access the data, a user, such as a client or vendor, must enter a valid login identifier in login text area 504 and a valid password associated with the login identifier in password text area 506. Only when a valid login identifier and password have been entered will a user be allowed to proceed to interact with the IPA system.

Upon entering a valid login and password, the user is presented with inquiry page 501 in presentation area 320 (FIG. 3), as shown in FIG. 5B. In one embodiment of the invention, inquiry page 501 includes a header 502, project frame 504, transaction identification 510, request information table 512, and comment box 518. Header 502 provides information regarding the component states (inquiry, offer, offer approval, order etc.) of a parts inquiry transaction. For each state, the party responsible for completing the state and the date the state was completed is provided.

Project frame 504 provides a mechanism for navigating through one or more projects associated with a client. In one embodiment of the invention, client projects are organized in a hierarchy that includes open projects, waiting projects, and finished projects. Open projects are those projects that require action on the part of the client regarding initial or outstanding requests, that is, requests for which parts have not been received yet. Waiting projects are those projects that require action on the part of a vendor of the part. Finished projects are those projects for which all of the requested parts have been received, resulting in a completed transaction. The “Messages” branch of the hierarchy serves as a message board, allowing a client and vendor to communicate with each other regarding project related issues.

In the exemplary inquiry page 501, project frame 504 has been sorted by project status (i.e. open, waiting, finished etc.), followed by project name. However, the invention is not limited to the sorting shown, and in alternative embodiments of the invention, the project frame 504 can be sorted by any one of three criteria: vendor, project identifier, and project status. For example, the project frame could be sorted by a parts vendor, followed by the project status, followed by the project name, followed by project status. Furthermore, the sort order can be defined by the user.

Transaction identification 510 provides information identifying the client and the vendor involved in the transaction. This information includes the client's and vendor's name and address, and can also include a system assigned identifier (a client number) for the client. Identifying information for various states of the transaction is also provided. For example, a request number is displayed that uniquely identifies a particular request. The user can enter a request name in request text box 508 to describe the request.

Request information table 512 provides information regarding the parts requested in the transaction. Parts can be added to the request as a result of executing a search as described in the previous section, or by manually adding a part to the request by clicking on an “add article” button as shown in FIG. 5D. In addition, parts can be added to a project by reading one or more parts from a bill of materials stored on a computer-readable medium such as a CD-ROM, floppy disk, hard drive, or other persistent storage.

In one embodiment of the invention, the information is displayed in a tabular format. The information displayed in the table includes a request number, a count for a particular part that identifies the position of the item inside a part list, an article number (also referred to as a part number or stock number) for the part, a textual description of the part, a quantity text box 513 providing for the entry of a desired quantity of the part, a price for the part, a discount amount for the part, the price of the part after the discount is applied, the tax rate for the sale of the part, and a resulting price for the part, including a currency for the transaction. Certain values, such as the resulting price, depend on the quantity entered in the quantity text box 513. Thus, in one embodiment of the invention, a save values and recalculate button 516 is provided to cause the entered values to be saved as part of the project, and the dependent values to be updated and redisplayed.

Comment box 518 provides a mechanism for a user to enter text, links or attachments regarding the parts request. The information can be a request for special processing of the request, a further description of the project, a question for the vendor etc. In addition, the information can be the name of an file attached to the parts request.

Action buttons 520 are used to control the state of the request transaction. For example, clicking on the “submit” button causes the portal server to set the inquiry state to completed, and to place the request in a offer state. The portal server also notifies the vendor of the request. Notification can be by e-mail, fax, or other electronic communication. In addition, notification can be made by updating a web page that is accessed by vendor's to inquire if any new requests have been directed to the vendor.

The suspend button causes the request to be suspended. Suspending a request preserves the current state of the request, that is, any input quantities, comment text, or other values are saved. This allows the client to provide request input over more than one session if desired. For example, the client may need to consult with other personnel before deciding on a particular part or quantity. The client can determine the appropriate input value, come back to the request page, and submit the previously suspended request when all information has been provided.

The reset button causes the request values in request information table 512 to be reset. Upon clicking on the reset button, the delete check-box, quantity text box 513 and comments text box 518 are cleared of any values or text, and the user can re-input appropriate values.

Projects can be added to the hierarchy by clicking on add project button 505. Upon pressing button 505, the user is prompted to enter information describing a project, such as the project name and the address for the project. Upon entering the required information, the newly added project is added to the project hierarchy 504. The information provided is stored in database 210. As the more information about the project is acquired by the system through the screens described below, that information is also added to the database 210. Thus the information persists across visits to the pages of the portal. This allows both clients and vendors to access the project information from time to time in order to perform updates and inquiries to the project.

In one embodiment of the invention, parts are entered into a project by using the search component described above to identify a particular part, and then clicking button 494 (FIG. 41) to cause the system to submit the identified part to the interactive purchasing agent component on the portal server. The project to add the part to can be identified by the project number or the part number.

FIG. 5K illustrates an inquiry page 1500 according to an alternative embodiment of the invention. Inquiry page 1500 provides similar functionality to that provided by inquiry page 501 described above, and in addition provides buttons 1510, 1508, and 1506. Button 1506 causes the system to transfer component data to the purchasing entity within a company employing the system of the embodiments of the invention. The transfer can be accomplished by transferring the component data via a communications link to a purchasing system, or the data can be encapsulated into an e-mail that is sent to purchasing department personnel. The purchasing personnel can then enter the data into a purchasing system. The invention is not limited to a particular transfer mechanism. Furthermore, the invention is not limited to any particular type of purchasing system. In one embodiment of the invention, the purchasing system is an ERP (Enterprise Resource Planning) system.

Button 1508 causes the system to submit the request information in table 512 to a search engine that can provide a list of suppliers that can provide the requested article. FIG. 4G described above illustrates an exemplary supplier list according to one embodiment of the invention.

Button 1510 causes the system to submit the request information in table 512 to a search engine that can search for auctions offer the part for bidding. In one embodiment of the invention, the part is specified by providing the UN-Spec classification for the part.

In one embodiment of the invention, the auction is maintained by the portal. In this embodiment, sellers register the parts they wish to auction with the portal, specifying the machinery classification of the part. In addition, the seller can supply other data, such as the minimum amount the seller will accept (the “reserve” amount) for the part, and the date and time the auction will begin and end. Upon a request by a potential buyer, the search engine then searches the auction data for a match to the desired part. Upon finding such a match, the current bid data can be displayed to the potential bidder. For example, the current high bid, current minimum bid increment, and auction close data can be displayed to the user, who can then make a decision whether to bid on the part, or to search for alternative suppliers of the part. In some embodiments of the invention, the seller of the part can indicate that they wish to remain anonymous, either until the transaction is ready to close (i.e. the high bid is accepted) or in perpetuity. In these embodiments, the web portal provider can be listed as the seller/provider of the part.

In an alternative embodiment of the invention, after receiving a parts specification, the search engine then scans a set of auction web-sites for matches to the specification. The set of auction web-sites that are searched can be determined by various factors. For example, in one alternative embodiment of the invention, the set of auction web-sites that are searched comprises a set of auction web-sites that have agreed to pay a commission or flat fee to the portal provider for each component that is sold through a referral to the auction web-site from the portal provider.

An initial offer frame 503 is shown in FIG. 5C. Offer frame 503 is displayed when a request transaction for a project has completed the inquiry state. Offer frame 503 includes header 502, transaction information 510, offer information 524, delete button 526, add button 528, save button 530, customer comment block 538, vendor comment block 534, and official drop-down box 536. Header 502 is updated to indicate the current state of the request transaction. The date that the inquiry state was completed is indicated, and the fact that the request is now in an offer state is indicated by highlighting the offer section of the header and showing “in process” as the state.

Previous states that have been completed, for example the inquiry state, are still accessible and can be modified by clicking on the “inquiry” link in header 502. This allows the client to revise the inquiry to include additional or different parts, and to modify the desired quantity. The vendor can then responds to the revised inquiry via the offer screen 503. This process can be repeated as many times as the client and vendor find necessary.

Transaction identification 510 is updated to show the request name as designated in text box 508 (FIG. 5B), and also includes an offer number assigned by the system.

Offer information table 524 provides offer information for one or more parts in a request. The information for each part in the request includes the offer number associated with the offer, a count, an article number for the part requested, a list price, a discount value, and a selling price. The information for each part also includes a quantity text box 522 and a discount percent text box 523, allowing a vendor to input a quantity and a discount for the request. For example, the vendor may not have enough parts in stock to satisfy the clients request. Providing quantity text box 522 allows the vendor to respond with a quantity the vendor does have in stock. Save button 530 causes the current state of the project to be saved, and the selling price value in table 524 to be updated to reflect the current quantity and discount amounts.

Delete button 526 allows a vendor to delete articles from table 524. Items to be deleted are checked using the indicated box in table 524, and, upon pressing delete button 426 are deleted from the table. This allows a vendor to remove articles that the vendor does not wish to offer to the client.

Add article button 528 allows a vendor to suggest an alternative to the part or parts that a client has requested. This is desirable, because the vendor may be able to suggest a better alternative than the part the client originally requested.

Comments area 538 displays any comments that the user entered in comments box 518 (FIG. 5B), such as special handling requests or other information associated with the parts request.

Offer comment box 534 provides an area for a vendor to input comments regarding the offer. For example, the vendor could note that the quantity was reduced due to insufficient stock on hand, or that a special one-time discount had been applied to the offer.

In frame 503, action buttons 520 are used to control the state of the offer transaction. For example, clicking on the “submit” button causes the portal server to set the offer state to completed, and to place the request in a offer approval state. The portal server also notifies the vendor's offer approval office of the request. Notification can be by e-mail, fax, or other electronic communication. In addition, notification can be made by updating a web page that is accessed by vendor's offer approval office to inquire if any new requests have been directed to the vendor.

The suspend button causes the request to be suspended. The current offer values that have been provided by the vendor are saved to database 210, and the vendor can return to the page to complete the offer process at a later time.

The reset button causes the input values in offer frame 503 to be reset. Upon clicking the reset button values or text in the delete check-box of, quantity text box 522 and discount percentage text box 523 of offer table 524, and comments box 534 are cleared, and the vendor can provide new values or text for the cleared items.

Vendor official drop-down box 536 allows a vendor to designate an official responsible for the offer. When selected, the drop-down box 536 displays a list of officials that are responsible for offers. The list of officials can be read from database 210 and presented in drop-down box 536. The vendor then selects one of the officials that will be responsible for the offer transaction indicated in transaction identifier 510.

Upon clicking or selecting the submit button from action buttons 520, the offer state is completed and the project moves to the offer approval state. An exemplary offer approval frame 507 is illustrated in FIG. 5D. In one embodiment of the invention, offer approval frame 507 is presented upon selecting a project from project frame 5B that is in the offer approval state. In this embodiment, offer approval frame 507 includes header 502, transaction identification block 510, offer approval table 538, delete button 526, add button 528, save button 530, comment box 534, official box 540 and action buttons 520. Header 502 is updated to show the date the offer state was completed and that the project is currently in the offer approval state.

Offer approval table 538 comprises information regarding the details of the offer requiring approval. This information includes the offer number, a count, a vendor's stock number, a description, a quantity, a discount value, a selling price, a tax rate for the article, an end price based on a discount percentage and the tax rate, and a currency for the transaction. Also included in the table is a discount percentage text box 539, which can initially contain a discount amount entered in text box 523 (FIG. 5C). It is desirable to provide a discount percentage text box 539, because it allows a person approving the offer to adjust the discount percentage as desired. The items shown in table 534 are provided by way of example, and no embodiment of the invention is limited to the particular items shown. Those of skill in the art will appreciate that other items can be substituted for those shown.

Save button 530 provides a mechanism to force the values shown in table 538 to be adjusted if the discount percentage input in text box 539 is changed.

Comments box 534 provides a mechanism for person responsible for approving offers to provide notations or comments regarding the transaction. These comments are stored in database 210, and presented in subsequent web-pages or frames of web-pages, as described below.

Vendor official block 540 shows the vendor official in charge of the offer, as determined by the vendors input into drop-down box 536 (FIG. 5C). Additional information regarding the vendor official, such as the official's telephone number can be obtained from database 210 and presented to the client browser in vendor official block 540.

Action buttons 520 control the current state of the project. Clicking on the submit button causes the portal update database 210 to update the currently selected project's status by setting the offer approval state to complete, and to set the current state to order. Clicking on the reset button causes the values in discount percentage box 539 to be reset to an initial value, and the comments box 534 to be cleared. Clicking on the suspend button causes the current values input by the vendor to the offer approval frame 507 to be stored to database 210. This allows the vendor to return to the screen at a later time to complete the offer approval process.

In an alternative embodiment of the invention (not shown), the workflow represented by the frames can also include a field to cause the order to be sent to the purchasing department. This provides a mechanism for the purchase department to finish the workflow, thereby integrating the purchasing department into the workflow.

Upon clicking or selecting the submit button from action buttons 520, the offer approval state is completed and the project moves to the order state. A notification is sent to the client that the offer has been approved. As noted above, this notification can be accomplished sending an e-mail, fax or mail message to the client. An exemplary order frame 509 is illustrated in FIG. 5E. In one embodiment of the invention, order approval frame 509 is presented upon selecting a project from project frame 504 (FIG. 5B) that is in the order state. In this embodiment, order frame 509 includes header 502, transaction identification block 510, order information table 542, vendor comments block 544, order comments text box 546, official block 540 and action buttons 520. Header 502 is updated to show the date the offer approval was completed, and that the project is now in the order state. Transaction identification block 510 is updated to provide a system generated order number to the transaction.

Order information table 542 provides information regarding the part or parts that comprise the order. This information includes the order number, a count, a vendor's article number, a text description of the part, an order quantity, an order price, an order discount percentage, an order discount value, a selling price, a tax rate, an end price, and a currency for the order transaction. The values for the fields in the table will be based on information in the portal database 210 as created and updated by previous client and vendor interactions with the portal web system through the pages described above.

Vendor comments box 544 displays comments entered by the vendor in previous screens, such as vendor comment box 534. Order comments text box 546 provides a mechanism for the client to provide additional information regarding the order. For example, the client could provide specialized delivery instructions. This information can then be stored in database 210 for presentation to the vendor in the screens described below.

Like the request and offer frames described above, action buttons 520 in order frame 509 control the state of the order transaction. Submit button provides a mechanism, that when clicked, cause the project's order state to be completed and to place the project in an order confirmation state. The vendor can be notified via e-mail, fax, or other communication of the new state to allow the vendor to confirm the order. Clicking on the reset button causes the text in the comments box 546 to be cleared. Clicking on the suspend button causes the current input values in order frame 509 to be saved to database 210, allowing the client to return to the screen to finish providing input values at a later date, without losing values entered so far.

An exemplary order approval frame 511 is shown in FIG. 5F. The order confirmation frame 511 is sent by the portal server to a client browser upon selection of a project from project hierarchy 504 (FIG. 5B) that is in the order confirmation state. Frame 511 includes header 502, transaction identification block 510, order confirmation table 548, customer comments block 550, confirmation comments text box 552, official block 540, and action buttons 520. Header 502 is updated to show the date the project completed the order state, and that the project state is currently the order confirmation state. Transaction identification block 510 is updated to add a system generated confirmation number.

Order confirmation table 548 provides details regarding the order. This information is similar to that in order information table 542, with the order number replaced with the confirmation number.

Customer comments block 550 displays comments, if any, entered by the client in order comments text box 546 (FIG. 5E).

Confirmation comments text box 552 allows the vendor to provide additional information regarding the order confirmation, for storage in database 210 and display on subsequent pages provided by the portal server.

Action buttons 520 control the current state of the project. Clicking on the submit button causes the order confirmation state to be completed, and the new project state to become the delivery state. A notification via e-mail, fax, or other communication can be sent to the vendor's delivery department. Clicking on the reset button causes the text in the confirmation comments box 552 to be cleared. Clicking on the suspend button causes the current input values provided by the vendor on order confirmation frame 511 to be saved to database 210, allowing the vendor to return to the page to finish providing input at a later time.

An exemplary delivery status frame 513 according to an embodiment of the invention is shown in FIG. 5G. The delivery status frame 513 includes header 502, transaction identification block 522, delivery status table 554, customer comments block 550, delivery comments text box 552, official block 540 and action buttons 520. Frame 513 is displayed when a project is selected from the project hierarchy 504 (FIG. 5B) that is in the delivery status state. Header 502 is updated to provide the date the order confirmation state was completed, and to show that the project is currently in the delivery status state.

Delivery status table 554 provides information regarding the delivery status of the transaction. In one embodiment of the invention, table 554 includes a confirmation number, a count, a vendor's part number, a description of the part, the quantity of the part that has been confirmed, and a remaining quantity comprising the number of parts confirmed, but not yet delivered. Table 554 also includes two text boxes, a delivered quantity text box 551 and a delivery date text box 553. The vendor can enter a quantity to be delivered in text box 551, and the date the delivery took place, or is to take place, in text box 553.

Action buttons 520 are used to control the current state of the project. Clicking on the submit button causes the delivery status state to be completed, and the project to advance to the goods receipt state. A notification can be sent to the client, indicating that the goods are to be delivered. Like the notifications above, the delivery notification can be sent via e-mail, fax or other communications method. Clicking on the reset button causes and comments entered in comments text box 552 to be cleared to allow submission of new comments.

An exemplary goods receipt frame 515 is illustrated in FIG. 5H. Goods receipt frame 515 is presented to a client browser by portal server 290 upon selection of a project from project hierarchy 504 (FIG. 5B) that is in a goods receipt state. Goods receipt frame 515 includes header 502, transaction identification block 510, receipt status table 556, vendor comments block 558, comments text box 552, official block 540, and action buttons 520. Header 502 is updated to indicate the date the project's delivery state was completed, and that the project is now in the goods receipt state.

Receipt status table 556 provides information describing the status regarding receipt of one or more parts ordered for the project from a vendor. This information includes a confirmation number, a count, a text description of each part, a confirmed quantity ordered, a remaining quantity, and a delivered quantity. Table 556 also includes two text boxes, a received quantity text box 555 and a received date text box 557. Received quantity text box 555 provides a mechanism for a client to supply a quantity of the ordered parts that have been received, and received date text box 557 provides a mechanism for the client to indicate the date that the ordered parts were received.

Comments text box 552 provides a means for the client to provide information regarding receipt of the goods. For example, the client could mention that the parts were received in good condition, or if there was any damage to the parts in shipment.

Action buttons 520 control the current state of the project. Clicking on the submit button causes portal server to update the database 210 to indicate that the goods receipt state has been completed, and that the current project state is a reception note state. In addition, clicking on the submit button can cause a receipt to be sent to the vendor. The receipt can be e-mailed, faxed, or printed and mailed to the vendor. Clicking on the reset button causes the received quantity text box 555, received date text box 557, and comments text box 552 to be cleared, thereby providing a way for the client to input new quantities, dates or comment text. Clicking on the suspend button causes the values current entered on goods receipt frame 515 to be saved to database 210. This allows the client to save the current state of the frame, and finish providing input at a later date or time.

An exemplary reception note frame 517 according to an embodiment of the invention is shown in FIG. 51. Reception note frame 517 is provided by the portal server to a client browser for display when a project is selected from project hierarchy 504 (FIG. 5B) that is in the reception note state. In this embodiment, reception note frame 517 includes header 502, transaction identification block 510, reception note table 558, official block 540, receptor block 560 and action buttons 520. Header 502 is updated to indicate the date that the goods receipt state was completed, and that the selected project is currently in the reception note state.

Reception note table 558 displays information regarding the receipt of one or more parts ordered for the selected project. For each part, an order confirmation number, an order count, a vendor part number, a part description, a confirmed quantity, a delivered quantity, a price, and a currency is displayed.

Receptor block 560 indicates a customer representative that is in charge of receiving the goods. A drop-down box is included in the receptor block and can be used to select an appropriate person. The list of candidates to present in the drop-down box is selected from database 210.

Action buttons 520 again control the current state of the project. Clicking on the submit button causes the project state to be completed. The database 210 is updated to reflect the new state. In addition, project moves from the open projects branch in the project hierarchy 504 (FIG. 5B) to the completed projects branch. Clicking on the reset button causes the input, such as the receptor in charge drop down box 560 to be reset to initial default values. Clicking on the suspend button causes the current input values to be saved to database 210, thereby allowing the user to leave the reception note frame 517, and return at a later time to finish providing input or submitting the reception note via the submit button.

A method for maintaining purchase transactions associated with projects is illustrated in FIG. 5J. The method begins when a user requests that the system create a project (block 580). The request can be issued by a client browser interfacing with the system as described above in reference to FIG. 5B. The system creates the project in a database, such as database 210. The project data can also be maintained as a file or set of files in a file system, as those of skill in the art will appreciate.

The system then receives part selections to be added to the project (block 582). The parts can be provided in several ways. For example, the parts may be provided as the result of executing a search engine, as described above, or the user may add parts by entering part data such as vendor name and part number on a web page. In addition, an electronic search assistant component, as described above, can be used to provide part selection. The database is then updated to associate the selected parts with the project (block 584).

Next, the system issues an inquiry to a vendor or vendors associated with the selected parts (block 586). The inquiry can be issued via e-mail, fax, or other electronic communication. In addition, details regarding the inquiry can be provided on a web page, such as the page described by FIG. 5C.

The system then receives offer data from the parts vendor (block 588). The offer data can be provided on a web page, as described above. The system updates the database with the offer data. In one embodiment of the invention, receiving offer data is a two step process in which offer data is initially provided and stored in the database. The offer data is then reviewed by vendor personnel and approved. The project creator is then notified that the offer data has been received. At noted above, the notification can be via electronic means such as e-mail or fax. In addition, the offer data can be presented to the project creator via a web page.

After the project creator has reviewed the offer data stored in the system, the project creator can cause the system to issue an order to the vendor (block 590). The system updates the database to indicate the order status, and the system also notifies the vendor of the order.

Next, the system receives and processes an order confirmation (block 592). In one embodiment of the invention, the order confirmation data is provided by the vendor via a web page maintained by the system.

In an alternative embodiment of the invention, the system receives updates on the delivery status of the order (block 594). The updates can be provided via a web page in which the vendor enters delivery quantities and dates as parts are readied for shipment. The system updates the project database with the data provided by the vendor.

In a further alternative embodiment of the invention, the system receives updates from the project creator as parts are received from the vendor. The quantity and date parts are received can be entered on a web page maintained by the system. The system then updates the project database with the receipt data.

At any point in the above described method, a customer or vendor can return to a previous point to update or modify data entered at the previous point, as indicated by dashed lines connecting the blocks in the flow chart. As an example, a customer could select new parts to be added to the project after an inquiry has been sent to a vendor. The system updates the database with the modified data, and issues notifications to the appropriate party to the transaction.

Furthermore, in some embodiments of the invention the customer can invoke the search engine at any point in the above-described process and submit the part description to auctions that may be able to supply the part. Thus the buyer can determine the lowest cost provider for the part at any point in the process. As an example, a “search in auctions” button, such as button 1510 (FIG. 5K) can be added to any of the screens in the embodiments of the invention depicted in FIG. 5C - 5J to cause the current component part data to be submitted as search parameters for on-line auctions.

This section of the detailed description has described an Interactive Purchasing Agent Component according to various embodiments of the invention. A series of frames have been described illustrating the movement of project through various stages of a customer/vendor purchase transaction. As those of skill in the art will appreciate, not all stages of the transaction described above need be present, and the invention is not limited to a particular order or number of project stages. For example, the order approval stage could be omitted from transaction process. In addition, other stages may be added to the process without departing from the scope of the invention.

### CAD Drawing Catalogue and Parametric CAD Engine

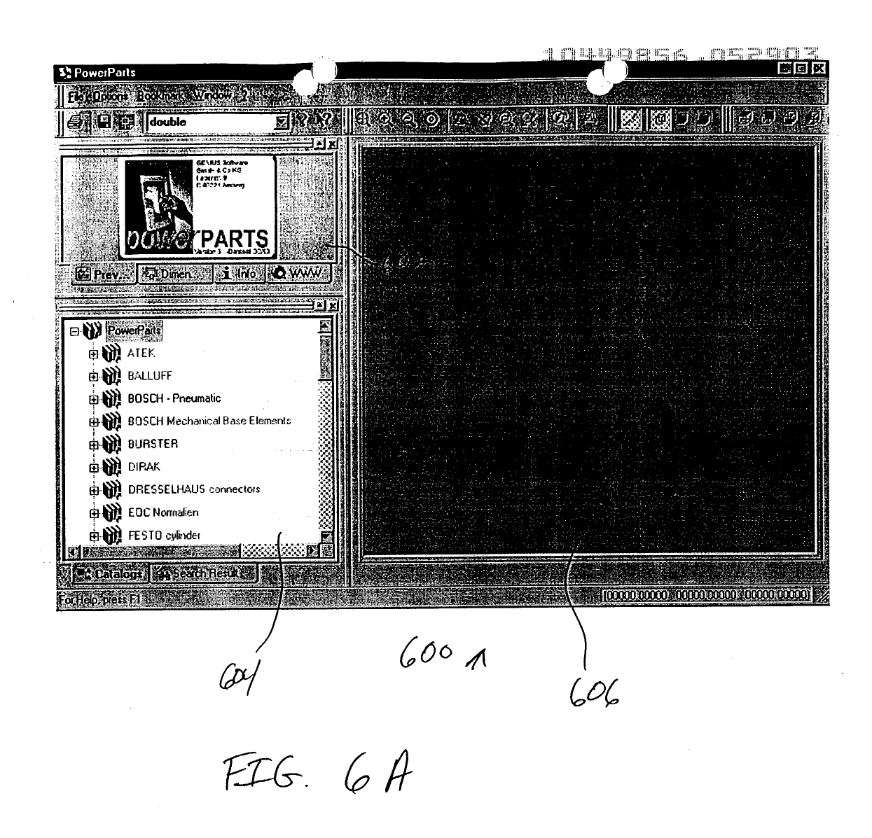

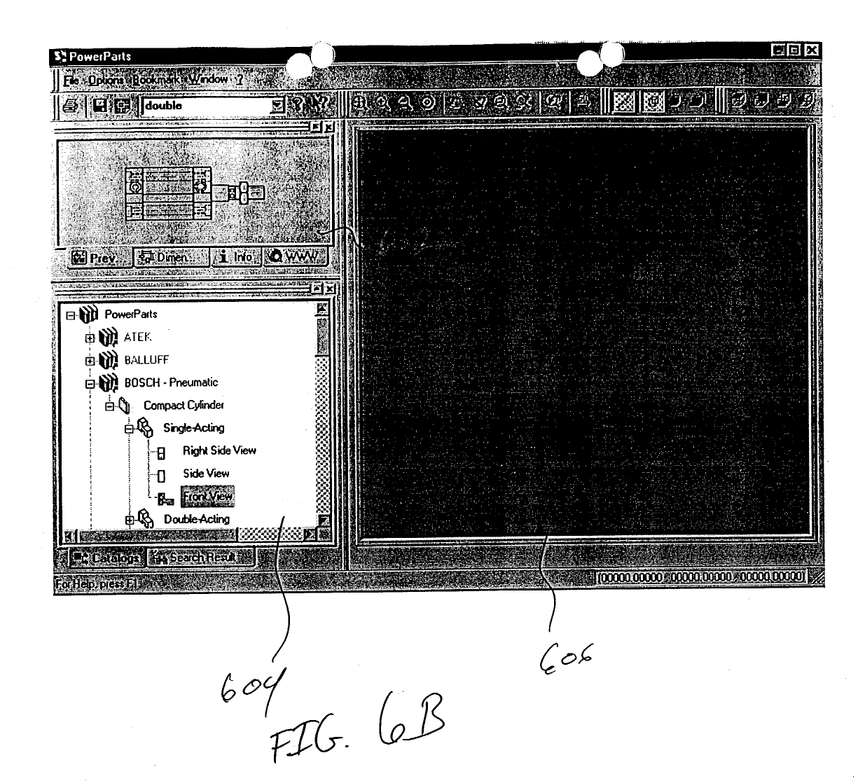

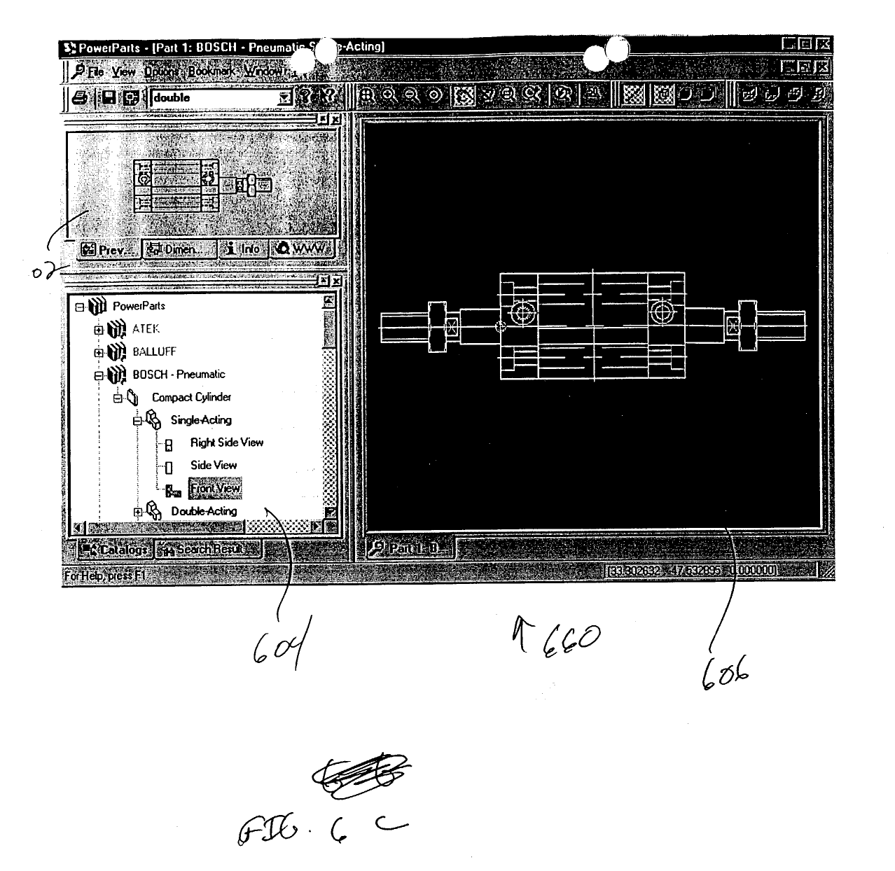

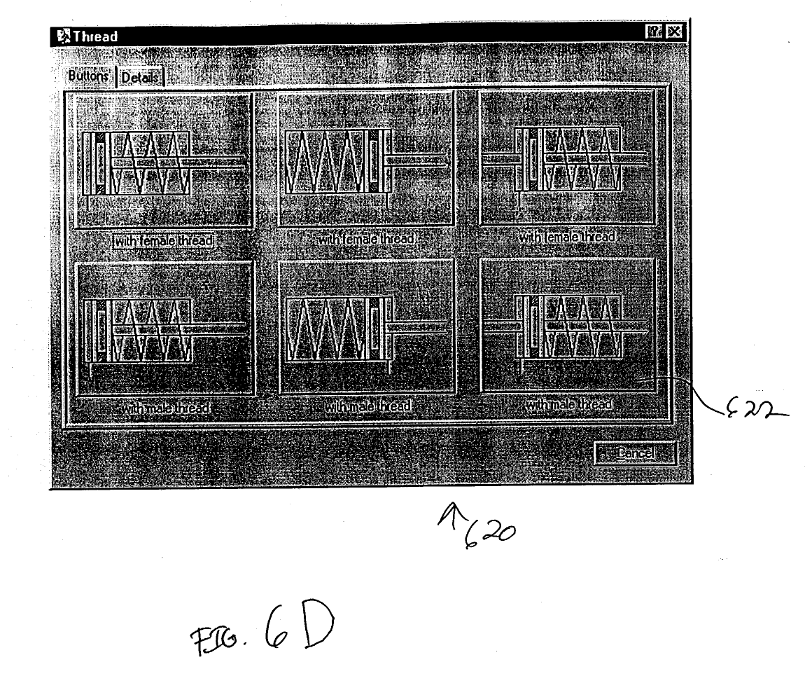

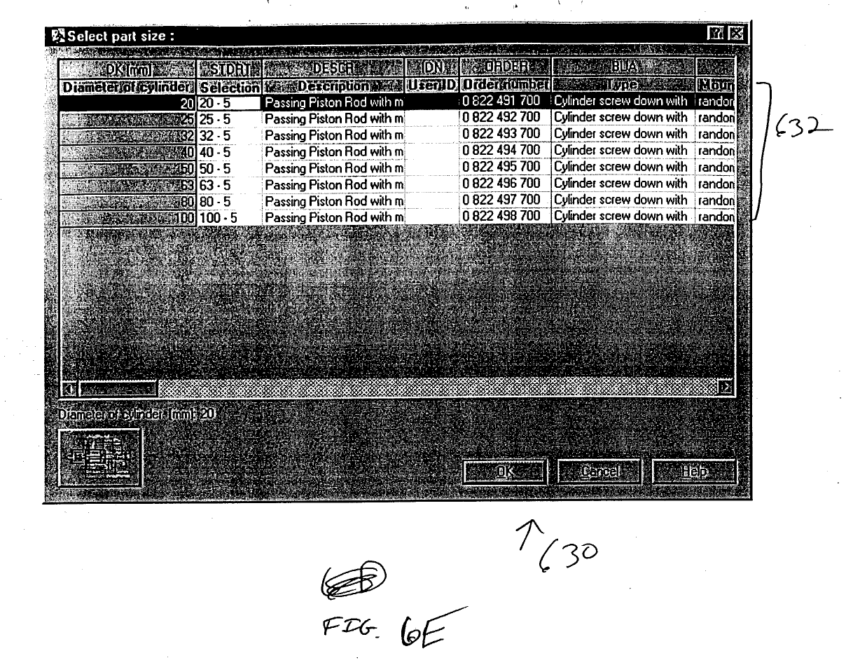

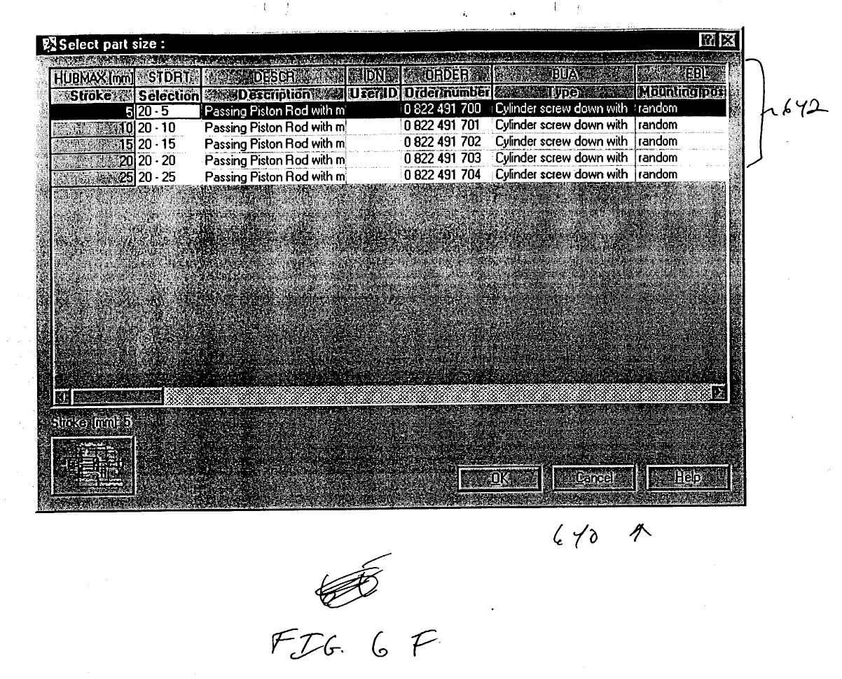

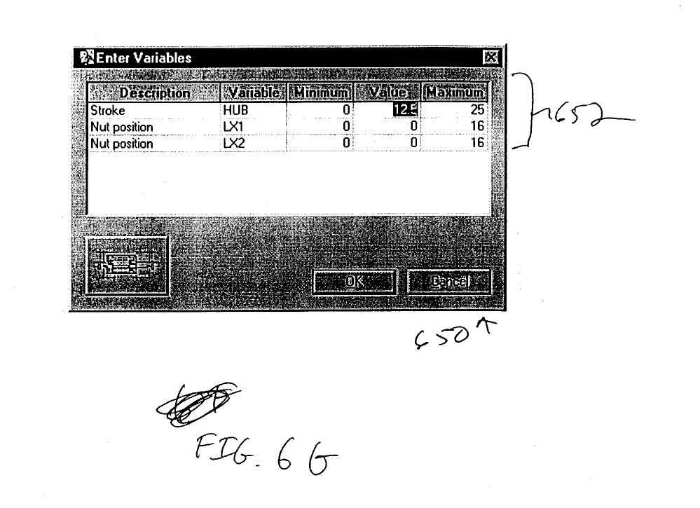

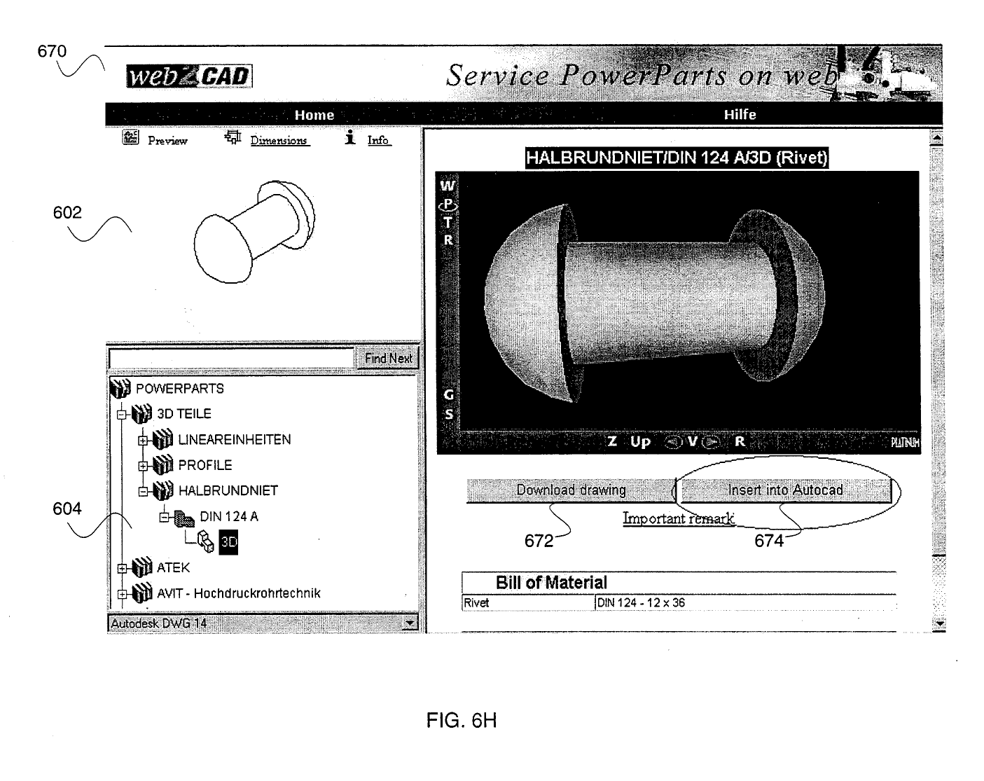

A further aspect of the mechanical engineering web portal according to an embodiment of the invention is the inclusion of a CAD drawing catalogue component and a parametric CAD engine component. In this embodiment, a portal provider maintains a database of CAD drawings. The drawings can be created on any CAD system, as is known in the art. The drawings maintained by the portal provider represent parts available from various vendors. Typically, the drawings will be created by the portal provider based on information available in parts catalogues available from the vendor. However, the invention is not so limited, and the CAD drawings can be provided by the vendor itself, or from other third parties. FIGS. 6A-6G illustrate the operation of the components according to one embodiment of the invention.

FIG. 6A shows an initial screen area 600 of the CAD drawing catalogue. In one embodiment of the invention, the initial screen 600 is displayed to a web client when a user selects the CAD Databank link shown on the portal screen 300 (FIG. 3) In this embodiment, the screen area 600 is displayed within the presentation area 320, however, the invention is not so limited, and in an alternative embodiment, the portal screen 300 is replaced by initial screen 600.

Initial screen 600 is comprised of three major frames, a mode frame 602, a parts frame 604 and a drawing frame 606. When a user first enters the CAD drawing component, the parts frame 604 contains a list of parts providers for which the portal provider maintains parts drawings, and drawing frame 606 is blank. The data used to generate the list is obtained from database 210 (FIG. 2). The user then selects a particular vendor from the parts list, typically via a point and click operation as is known in the art. Upon selecting a particular vendor, the list is expanded to show a list of parts available from the vendor. Selecting one of the available parts causes the list in parts frame 604 to be further expanded to include the drawings available for the part.

FIG. 6B illustrates an exemplary embodiment of the invention where the user has indicated that drawings for single-acting compact cylinders from Bosch are desired. As illustrated in FIG. 6B, various levels of detail are possible in the parts frame 604. As the list expands, more detail about the part is provided, until drawings representing various views of the part are provided in the list. In addition, in one embodiment of the invention, a generic view of the part is presented in mode frame 602.

As shown in FIG. 6B, the list in parts frame 604 is a tree-structured list, with branches of the tree providing further detail. The structure of the list is maintained in database 210, along with the data describing the available vendors, parts and drawings. The outermost level of detail comprises the available vendors. The next level describes the parts available from the vendor. At the next level, a list of available views is presented. Drawings typically represent a single view of the part, for example, a top, left side, or right side view. However, the invention is not so limited, and a single drawing can contain multiple views.

In one embodiment of the invention, the tree structure described above can be personalized by a user. In this embodiment, the user can add a branch comprising a “Favorites” list. The Favorites branch of the tree structure can contain the manufacturers, part groups, or parts that the user frequently uses. It is desirable to provide such a Favorites branch, because it saves the user time in the parts drawing selection process.

In a further embodiment of the invention, the list entries include reference identifiers. The text of the entry is associated with the reference and stored separately in the database, or as a file in the file system. It is desirable to maintain the text separately and use reference identifiers to associate particular text with an entry, because it allows the tree to be displayed in a language independent manner. If a particular language is desired, the system selects the appropriate file containing the desired language and reference identifiers, or alternatively, the desired language text is loaded into the database 210.

In one embodiment of the invention, the web portal system includes a tree generation component. This component is used to generate a tree structured list of parts and drawings for a particular vendor. The list can then be added to database 210 as a new list, or it can merged with a previously existing list. In this embodiment, a user is provided a graphical user interface used to generate the tree structure. The user can add comments, attachments and HTML links to each entry in the list. A further aspect of this embodiment is that a library of often used parts is provided. The user can use GUI to select entries from the library for inclusion in the new tree structured list. The GUI can provide a “drag and drop” interface as is known in the art, or alternatively, a cut and paste operation as is known in the art can be used to copy components in the library to the tree structured list.

FIG. 6C illustrates a screen area 660 following the download of a drawing according to an exemplary embodiment of the invention. In this embodiment, the drawing is downloaded from a database 210 (FIG. 2) maintained by the portal provider for display in drawing frame 606 of screen area 660. The download is initiated when a user selects a particular drawing from the parts list presented in parts frame 604.

In addition to sending the drawing to the client web browser, the portal provider adds a billing entry to the database 210. The billing entry includes information regarding the vendor of the part illustrated by the drawing that was downloaded to the client web browser. Other information can be included in the billing entry, such as the time of the download, and identifying information regarding the party who initiated the download. At predetermined intervals, the billing entries for a particular vendor are accumulated and an invoice is generated to send to the vendor. The predetermined intervals can be daily, weekly, monthly, quarterly or yearly, the invention is not limited to any particular predetermined interval. In addition, the interval can occur upon entry of the billing record. As can be seen from the above, the vendor is charged for each download of a part drawing representing one or more of the vendor's parts. It is desirable to charge a vendor upon download of a drawing, because it allows the web portal provider to provide for the conversion of the vendor's parts catalogue to engineering drawings at little or no up-front cost to the vendor. The web-portal provider then receives revenue from the vendor for the subsequent downloads of the drawings representing the vendor's parts, or for “hits” on the vendor's data appearing on the web-portal provider's web pages. The revenue can be in the form of charging the vendor a particular amount for each download, or the revenue can be in the form of a percentage of parts ordered as a result of the download of the drawing.

In another embodiment of the invention (not shown), the user is charged for downloading the drawing instead of, or in addition to, charging the vendor for the download. The user can be charged using a variety of mechanisms. For example, the system can prompt the user to enter a credit card number before the download is initiated. In a addition, the system can register billing information for the user, and create billing records and invoices to be sent to the user in the same manner as for parts vendors.

In an alternative embodiment of the invention, user can download a group of parts. The group can comprise a set of similar parts (e.g., all of the cylinders produced by a manufacturer), or a set of related parts (e.g. a cylinder, a mounting block for the cylinder, and the bolts for mounting the cylinder). In addition, the group can comprise all of the parts available from a particular manufacturer. In this embodiment, the vendor can be charged an amount equal to the per-drawing charge for each of the drawings downloaded as a unit, or the vendor can be charged a reduced amount reflecting a quantity discount.

In a further alternative embodiment of the invention, the user must supply information in order to identify a specific part before downloading the part drawing. For example, in order to specify a pneumatic cylinder part, the user may need to select a thread pattern, a cylinder diameter, and a stroke measurement for the cylinder. An example of the operation of this embodiment is illustrated in FIGS. 6D-6F. This example is based on the user's selection of a cylinder part from parts list 604. The user is then prompted to enter a thread configuration for the part as shown in FIG. 6D. The options are presented as series of buttons 622 in frame 620. The user selects a thread configuration by pointing and clicking on the appropriate button 622.

In addition to graphical prompts as illustrated in FIG. 6D, the user may also be presented with textual prompts. FIG. 6E illustrates an exemplary text prompt 630 used to specify the diameter of the cylinder part. A table of available diameters 632 is displayed in prompt 630. The user then selects the desired diameter for the table 632. An exemplary prompt 640 for the stroke is presented in FIG. 6F. Table 642 provides the available stroke sizes for the cylinder part based on the user's previous selection of the cylinder diameter. The user then selects the desired stroke size from table 642.

After the user has satisfied all of the prompts, the appropriate drawing is downloaded from database 210 and displayed to the user. In addition, a billing entry is created in order to enable the portal provider to charge the part vendor for the download.

In some embodiments of the invention, in addition to downloading a drawing, the user can submit the parameters obtained via the prompts above to a search engine. The search engine can then search manufactures, distributors and retailers on-line databases for vendors that can supply the part represented by the drawing. In an alternative embodiment of the invention, the search engine can search for auctions that offer the specified part for bidding. The auction can be one maintained by the web portal provider, as discussed above, or it can be an on-line auction web site.

In a still further alternative embodiment of the invention, the portal provider includes a parametric CAD engine that allows a user to download a part drawing that represents a part that has been customized through the selection of available options via the parametric CAD engine. The customized drawing is then displayed in drawing frame 606. In this embodiment, customization parameters are associated with parts drawings available from the CAD drawings 265 in database 210. The user is prompted to enter the parameters associated with the drawing through prompts such as the customization table 632 illustrated in FIG. 6G. In this example, the customization parameters in table 632 include a stroke size, and positions for two mounting nuts. Table 632 includes minimum and maximum values for each parameter. The user enters the desired data for each parameter and indicates that all desired data has been supplied by clicking on the “OK” button. If a user fails to enter a value for one of the parameters, a default value can be supplied or, alternatively, an error message can be displayed if the parameter is a required parameter.

After all parameters have been supplied, either through user entry or by default values, the part drawing is customized according to the options the user has selected and the drawing is downloaded to the user's web browser for display in drawing area 606. In addition, information regarding the part, such as part numbers and option numbers can be displayed to the user. This additional information can be turned on or turned off according to the user's preference.

The illustrations in FIGS. 6A-6G described above have been presented in the context of a pneumatic cylinder part from a particular vendor. Those of skill in the art will recognize that different selection criteria and different parameters are required for other types of parts from various vendors. These differing parameters and selection criteria are within the scope of the invention.

In addition to downloading drawings, as described above, some embodiments of the invention provide a mechanism for drawings to be inserted into CAD systems. FIG. 6H provides an exemplary screen 670, which includes download button 672 and insert button 674. Download button 672 causes the drawing to be downloaded into the user's system for later use. Electronically pressing insert button 674 causes the system to receive the drawing from the source, and to automatically insert the drawing into a CAD system. In one embodiment of the invention, the drawing data is read from the network, and inserted into the current session of the CAD system. This allows the engineer to add the new component to an existing assembly. Alternatively, the drawing data can be read into a file in a temporary directory and then inserted into the CAD system. In one embodiment of the invention, the CAD system is the Autocad system, however the invention is not limited to any particular CAD system. It is desirable to provide for the automatic insertion of drawing data into a CAD system, because it allows a user to insert a three-dimensional representation of a part into the CAD system, and then user the CAD system to generate any desired two-dimensional views.

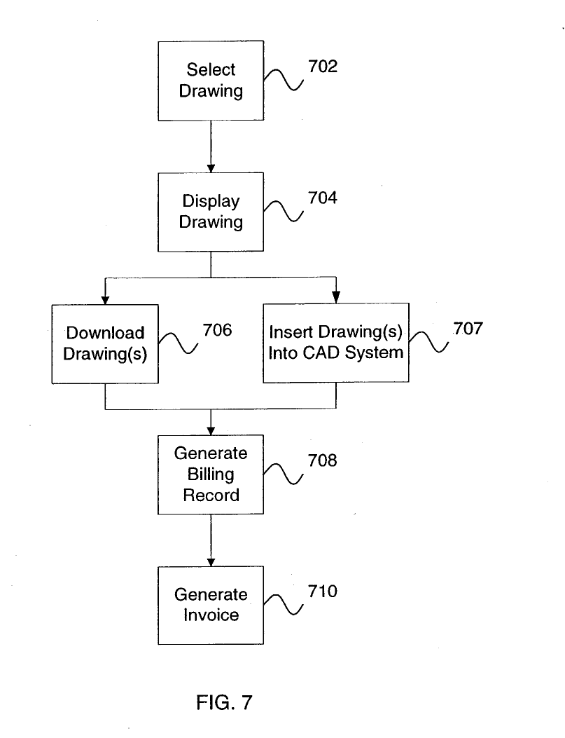

A method 700 of selecting a parts drawing for downloading and charging for the download is illustrated in FIG. 7. The method begins when the system provides a selection interface to a user allowing the user to select one or more CAD drawings (block 702). In one embodiment of the invention, the system provides the selection interface to a client computer on a web page as a tree structured list, as described above in reference to FIGS. 6A-6G. The user selects from the tree one or more drawings.

As drawings are selected, an image of the drawing is displayed to the user (block 704). The CAD drawing can then be downloaded to the client system (block 706) or inserted into a CAD system (block 707). Upon downloading a drawing to a client system or inserting a drawing into a CAD system, the system executing the method generates a billing record and enters the billing record into a database (block 708). The billing record identifies the drawing and a vendor of the part represented by the drawing. At predetermined intervals, the system generates invoices to be issued to the vendor (block 710). The invoices contain data from the billing records maintained in the database and represent the charges the vendor is to pay to the system provider for downloads of the vendor's part drawings.

### Conclusion

A mechanical engineering web-portal has been described. Although specific embodiments have been illustrated and described herein, it will be appreciated by those of ordinary skill in the art that any arrangement which is calculated to achieve the same purpose may be substituted for the specific embodiments shown. For example, while the embodiments of the invention have been described in the context of a web portal user interface comprising a number of screen areas and pages, the systems and method can be implemented using any of a variety of graphical user interfaces and capable of communicating over a network. This application is intended to cover any adaptations or variations of the present invention. Therefore, it is manifestly intended that this invention be limited only by the following claims and equivalents thereof

What is claimed is:

1. A computerized system for providing engineering information, said system comprising:
a computer comprising a processor, a memory, and a computer-readable medium operatively coupled together;
a database management component operative to manage a database that stores part data for each of a plurality of parts available from a vendor, said part data including at least one drawing and at least one attribute of the part; and
a web server component operative to download at least one of the plurality of drawings to a client computer and to insert the drawing into a Computer Aided Design (CAD) system.

2. The computerized system of claim 1, wherein the CAD system is the Autocad System.

3. A computerized system for providing engineering information, said system comprising:
a computer comprising a processor, a memory, and a computer-readable medium operatively coupled together;
a database management component operative to manage a database that stores part data for each of a plurality of parts available from a vendor, said part data including at least one drawing and at least one attribute of the part; and
a search engine component operative to receive a part specification and to search at least one database for a part provider.

4. The computerized system of claim 3, wherein the database includes auction data comprising parts for sale.

5. The computerized system of claim 4, wherein the auction data includes on-line auction sites.

6. A computerized method comprising:
displaying at least one drawing of a part from a vendor;
downloading the at least one drawing to a client computer; and
inserting the drawing into a CAD system.

7. The computerized method of claim 6, further comprising charging the vendor a fee upon the downloading of the drawing.

8. The computerized method of claim 6, further comprising charging a party downloading the drawing a fee.

9. The computerized method of claim 6, wherein the at least one drawing comprises a set of drawings.

10. The computerized method of claim 9, wherein the set of drawings comprises a plurality of drawings related to a part.

11. The computerized method of claim 9, wherein the set of drawings comprises a plurality of drawings of parts available from a particular manufacturer of the parts.

12. The computerized method of claim 7, wherein charging the vendor comprises adding a billing record to a data base and further comprising issuing an invoice to the vendor, said invoice comprising data from the billing record.

13. The computerized method of claim 7, wherein charging the vendor comprises receiving a percentage of the revenue of the part when the part is ordered from the vendor after the drawing is downloaded.

14. The computerized method of claim 6, wherein the at least one drawing is provided by the vendor.

15. The computerized method of claim 6, wherein the at least one drawing is created by a web-portal provider based on a description of the part provided by the vendor.

16. The computerized method of claim 6, wherein the part drawing is produced by an engineering computer aided design (CAD) system.

17. A computerized method for querying a database of parts, said parts having names; said names having at least one attribute type, said attribute type having an attribute value, the method comprising:
specifying a search keyword, a search attribute type and a search attribute value;
issuing a query to the database of parts specifying the search keyword, the search attribute type and the search attribute value; and
displaying a list of auctions that offer a set of parts returned in the query for bidding.

18. The computerized method of claim 17, wherein the list of auctions include on-line auctions.

19. A computerized method of designing a part, the method comprising:
selecting a part from a database, said part having a plurality of attributes, each said attributes having an attribute value;
for each attribute of the part executing the tasks of:
determining if the attribute value is a null value;
if the attribute is a null value prompting a user to enter the attribute value;
generating a drawing of the part in accordance with the attribute values of the plurality of attributes; and
inserting the drawing into a CAD system.

20. A computerized method for selecting at least one service provider, the method comprising:
receiving a query from a requester, said query including at lease one parameter describing a component part;
searching a database having data describing a plurality of service providers;
returning a list of service providers wherein the data describing the service providers in the list matches the at least one parameter;
receiving a selection of a subset of the list of service providers; and
submitting a request for the component part to a service provider in the subset of the list of service providers.

21. The computerized method of claim 20, further comprising:
receiving a response to the request from the service provider in the subset of the list of service providers; and
returning the response to the requestor.

22. The computerized method of claim 21, further comprising:
determining a time value representing an amount of time between submitting the request to the service provider and receiving the response to the request from the service provider; and
storing the time value in the database.

23. The computerized method of claim 22, further comprising calculating an average response time using the time value.

24. The computerized method of claim 23, wherein the list of service providers is categorized by the average response time.

25. The computerized method of claim 20, wherein at least one service provider in the database pays a fee for inclusion in the database.

26. The computerized method of claim 25, wherein the fee is paid on a periodic basis.

27. The computerized method of claim 25, wherein the fee is paid upon receipt of a request from the requester.

28. The computerized method of claim 20, further comprising displaying a map, and wherein the parameter includes a geographic specification selected from the map.

29. A computer-readable medium having computer-executable instructions for performing a method, the method comprising:
displaying at least one drawing of a part from a vendor;
downloading the at least one drawing to a client computer; and
inserting the drawing into a CAD system.

30. The computer-readable medium of claim 29, wherein the method further comprises charging the vendor a fee upon the downloading of the drawing.

31. The computer-readable medium of claim 29, wherein the method further comprises charging a party downloading the drawing a fee.

32. The computer-readable medium of claim 29, wherein the at least one drawing comprises a set of drawings.

33. The computer-readable medium of claim 32, wherein the set of drawings comprises a plurality of drawings related to a part.

34. The computer-readable medium of claim 32, wherein the set of drawings comprises a plurality of drawings of parts available from a particular manufacturer of the parts.

35. The computer-readable medium of claim 30, wherein charging the vendor comprises adding a billing record to a data base and further comprising issuing an invoice to the vendor, said invoice comprising data from the billing record.

36. The computer-readable medium of claim 30, wherein charging the vendor comprises receiving a percentage of the revenue of the part when the part is ordered from the vendor after the drawing is downloaded.

37. The computer-readable medium of claim 29, wherein the at least one drawing is provided by the vendor.

38. The computer-readable medium of claim 29, wherein the at least one drawing is created by a web-portal provider based on a description of the part provided by the vendor.

39. The computer-readable medium of claim 29, wherein the part drawing is produced by an engineering computer aided design (CAD) system.

40. A computer-readable medium having computer executable instructions for performing a method for querying a database of parts, said parts having names; said names having at least one attribute type, said attribute type having an attribute value, the method comprising:
specifying a search keyword, a search attribute type and a search attribute value;
issuing a query to the database of parts specifying the search keyword, the search attribute type and the search attribute value; and
displaying a list of auctions that offer a set of parts returned in the query for bidding.

41. The computer-readable medium of claim 40, wherein the list of auctions include on-line auctions.

42. A computer-readable medium having computer executable instructions for performing a method of designing a part, the method comprising:
selecting a part from a database, said part having a plurality of attributes, each said attributes having an attribute value;
for each attribute of the part executing the tasks of:
determining if the attribute value is a null value;
if the attribute is a null value prompting a user to enter the attribute value;
generating a drawing of the part in accordance with the attribute values of the plurality of attributes; and
inserting the drawing into a CAD system.

43. A computer-readable medium having computer executable instructions for performing a method for selecting at least one service provider, the method comprising:
receiving a query from a requestor, said query including at lease one parameter describing a component part;
searching a database having data describing a plurality of service providers;
returning a list of service providers wherein the data describing the service providers in the list matches the at least one parameter;
receiving a selection of a subset of the list of service providers; and
submitting a request for the component part to a service provider in the subset of the list of service providers.

44. The computerized method of claim 20, further comprising:
receiving a response to the request from the service provider in the subset of the list of service providers; and
returning the response to the requester.

45. The computer-readable medium of claim 44, wherein the method further comprises:
determining a time value representing an amount of time between submitting the request to the service provider and receiving the response to the request from the service provider; and
storing the time value in the database.

46. The computer-readable medium of claim 45, wherein the method further comprises calculating an average response time using the time value.

47. The computer-readable medium of claim 46, wherein the list of service providers is categorized by the average response time.

48. The computer-readable medium of claim 43, wherein at least one service provider in the database pays a fee for inclusion in the database.

49. The computer-readable medium of claim 48, wherein the fee is paid on a periodic basis.

50. The computer-readable medium of claim 48, wherein the fee is paid upon receipt of a request from the requestor.

51. The computer-readable medium of claim 43, wherein the method further comprises displaying a map, and wherein the parameter includes a geographic specification selected from the map.
